(19) United States
(12) Patent Application Publication
(10) Pub. No.: US 2026/0341663 A1
(43) Pub. Date: Oct. 29, 2026

(54) DUAL-FUNCTION ION TRAP MASS SPECTROMETER ASSEMBLY WITH INTEGRATED IONIZATION AND DETECTION, AND A METHOD THEREOF

(71) Applicant: Detect-ION, Tampa, FL (US)

(72) Inventors: Ashish Chaudhary, Odessa, FL (US); Dustin McRae, Land O Lakes, FL (US)

(21) Appl. No.: 19/464,748

(22) Filed: Jan. 30, 2026

Related U.S. Application Data
(60) Provisional application No. 63/752,171, filed on Jan. 31, 2025.

(51) Int. Cl. H01J 49/42; H01J 49/16

(52) U.S. Cl. CPC H01J 49/4235; H01J 49/161; H01J 49/4225

(57) ABSTRACT

A dual-function ion trap mass spectrometer assembly with integrated ionization and detection, and a method thereof are disclosed. The ion trap mass spectrometer assembly includes a light source, a microchannel plates stack, an electrically conductive component, an ion trap, and a control circuit. The light source is configured to emit ultraviolet photons. The microchannel plates stack includes first face opposite to second face and channels. The channels extend between first face and second face. The electrically conductive component is disposed between light source and first face of microchannel plates stack. The ion trap is disposed adjacent to second face of microchannel plates stack. The control circuit is configured to operate microchannel plates stack in ionization mode and detection mode. The microchannel plates stack may act as electron source during ionization mode. Further, the microchannel plates stack acts as an ion detector during detection mode.

### CROSS-REFERENCE TO RELATED APPLICATIONS

This application claims the benefit of the earlier-filed provisional application 63/752,171, filed on Jan. 31, 2025, entitled “Mass Spectrometer Ion Optics Design,” the contents of which are incorporated herein by reference.

### TECHNICAL FIELD

This patent application is directed to analytical systems and, more specifically, to a dual-function ion trap mass spectrometer assembly with integrated ionization and detection, and a method thereof.

### BACKGROUND

Generally, an existing mass spectrometer (MS) system provides a qualitative measurement and a quantitative measurement of a plurality of elements of a periodic table and a plurality of compounds formed through a plurality of chemical reactions. Further, an analytical capability of the mass spectrometry renders a plurality of instruments fundamental in research and essential across a plurality of applications. The plurality of applications may include, such as, for example, but not limited to, a medical diagnostics application, a chemical monitoring application, an environmental analysis application, and a threat detection application. Furthermore, the existing mass spectrometry system operates by processing a plurality of sampled compounds. In addition, the existing mass spectrometry system generates a plurality of signals. The plurality of signals corresponds to a plurality of mass to charge ratios. Furthermore, the existing mass spectrometry system allows an identification and a characterization of a plurality of detected species. In addition, the existing mass spectrometry system is based on at least three principal operations. The at least three principal operations include an ionization of the plurality of sampled compounds, a spatial separation and/or a temporal separation of a plurality of generated ions within a plurality of electromagnetic fields, and a detection of a plurality of separated ions. Further, a plurality of detected signals is correlated with a plurality of known reference compounds to generate reproducible mass spectra. The reproducible mass spectra are used for a compound identification and a quantification. Furthermore, a plurality of techniques has been developed to perform ionization, separation, and detection. Further, each of the ionization, separation, and detection performed provides one or more different performance characteristics depending on an application.

Typically, one class of a plurality of mass analysers employs a plurality of ion traps. The plurality of ion traps utilizes a set of electrodes driven by a Radio Frequency (RF) voltage and a Direct Current (DC) voltage. Further, the plurality of ion traps establishes quadrupole electric fields capable of confining a plurality of ions. Further, the RF voltage and the DC voltage are adjusted and/or scanned to modify a stability of a trapping potential, which causes the plurality of ions to become unstable. Furthermore, the plurality of ions is ejected from a trap according to the respective plurality of mass to charge ratios. In addition, the temporally separated ions are subsequently detected, and the resulting signals are processed to generate a mass spectrum. The mass spectrum represents a signal intensity as a function of a mass to charge ratio. Further, a conventional mass spectrometry architecture frequently relies on a plurality of distinct components for an electron generation, an ionization, and an ion detection. Furthermore, one or more separate electron sources and a plurality of microchannel plate (MCP) detectors are employed to provide an electron ionization operation and an ion detection operation. The conventional mass spectrometry architecture provides a plurality of limitations by increasing a system complexity, a system size, and a power consumption. Further, the plurality of limitations may be particularly pronounced in a compact mass spectrometry system and/or a resource-constrained mass spectrometry system, which are intended for a portable application, an embedded application, and/or a field-deployable application.

Consequently, FIGS. 1A-1C illustrate structural representations depicting operational configurations of an existing Electron Ionization Mass Spectrometry (EI-MS) system 100A with two Micro Channel Plates (MCPs) stacks for an electron generation and an ion detection, according to a prior art. According to FIGS. 1A-1C, a conventional multi-stage mass spectrometry workflow applying the two Micro Channel Plates (MCPs) stacks for generating electrons and detecting ions may be depicted. FIG. 1A illustrates an existing Electron Ionization Mass Spectrometry (EI-MS) system 100A. As shown in FIG. 1A, a plurality of sample molecules is introduced into a vacuum chamber 102A. The vacuum chamber 102A includes an Ultraviolet Light Emitting Diode (UV LED) 104A, a Micro Channel Plate (MCP) stack-1 106A, a Micro Channel Plate (MCP) stack-2 108A, a μ-ion trap array 110A, and the MCP stack-2 108A coupled to an anode 112A. The Micro Channel Plate (MCP) stack-1 106A is as an electron source 114A. The Micro Channel Plate (MCP) stack-2 108A is as an ion detector 116A. Further, the existing Electron Ionization Mass Spectrometry (EI-MS) system 100A includes an electronic pre-amplifier 124B. FIG. 1B illustrates an operation configuration 100B of the existing Electron Ionization Mass Spectrometry (EI-MS) system 100A. The operation configuration 100C depicts an activation of the UV LED 106B to generate a plurality of primary electrons. The plurality of primary electrons is amplified by the MCP stack-1 106A to form a broad electron beam directed toward the μ-ion trap array 110A for ionization. Further, part (A) of FIG. 1C illustrates an operation configuration 100C of the existing Electron Ionization Mass Spectrometry (EI-MS) system 100A. Furthermore, the operation configuration 100D includes an ejection of the ions from the μ-ion trap array 110A toward the MCP stack-2 108A. In the MCP stack-2 108A, the ions are amplified and detected to generate a mass spectrum 102D. In addition, part (B) of FIG. 1C illustrates a graphical representation of the mass spectrum 102D. Further, the operational configurations of FIGS. 1A-1C, rely on the MCP stack-1 106A and the MCP stack-2 108A operating in a plurality of stages as the electron source 114A and the ion detector 116A. The MCP stack-1 106A and the MCP stack-2 108A increases the complexity of the existing Electron Ionization Mass Spectrometry (EI-MS) system 100A. Further, the MCP stack-1 106A and the MCP stack-2 108A require a precise coordination of voltages, timing, and a spatial alignment between a plurality of discrete components. Furthermore, the MCP stack-1 106A and the MCP stack-2 108A thereby limits an architectural simplification and an integration flexibility of the existing Electron Ionization Mass Spectrometry (EI-MS) system 100A.

Consequently, a plurality of existing mass spectrometry systems applies one or more cold electron sources generated using an ultraviolet radiation in combination with a plurality of microchannel plates (MCPs) for ionization. Further, a time of flight mass spectrometer system and an ion trap mass spectrometer system utilize a plurality of ultraviolet irradiated microchannel plates (MCPs) together with a spatially separated ionization, a separation region, and a detection region. Further, the time of flight mass spectrometer system and the ion trap mass spectrometer system utilize a plurality of electron amplification and conditioning stages. The plurality of electron amplification and conditioning stages generate and deliver a plurality of electron beams into an ion analyzer. Furthermore, architectures of the time of flight mass spectrometer system and the ion trap mass spectrometer system rely on a plurality of distinct subsystems for an electron generation, a beam shaping, and an ion detection. The plurality of distinct subsystems increase an operational complexity and impose a plurality of constraints on a timing coordination, a voltage control, and an integration of the plurality of existing mass spectrometry systems.

Consequently, there is a need for an improved dual-function ion trap mass spectrometer assembly with integrated ionization and detection, and an improved method thereof, which may reduce an architectural complexity, maintain a reliable ionization and detection performance with an efficient electron generation and ion detection using a simplified detector architecture, and a reduced component count, and to address at least the aforementioned issues in the prior arts.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure may provide an ion trap mass spectrometer assembly. The ion trap mass spectrometer assembly may include a light source, a microchannel plates stack, an electrically conductive component, an ion trap, and a control circuit. The light source may be configured to emit ultraviolet photons. The microchannel plates stack may include a first face opposite to a second face and a plurality of channels. The plurality of channels may extend between the first face and the second face. The electrically conductive component may be disposed between the light source and the first face of the microchannel plates stack. Further, the electrically conductive component may be configured to transmit at least a portion of the ultraviolet photons toward the microchannel plates stack. Furthermore, the electrically conductive component may be configured to collect electrons exiting the microchannel plates stack. The ion trap may be disposed adjacent to the second face of the microchannel plates stack. The control circuit may be configured to operate the microchannel plates stack in at least one of an ionization mode and a detection mode. The microchannel plates stack may act as an electron source during the ionization mode. Further, the microchannel plates stack may act as an ion detector during the detection mode.

Another aspect of the present disclosure may provide method of operating an ion trap mass spectrometer assembly. The method may include applying ultraviolet photons from a light source through an electrically conductive component towards a first face of a microchannel plates stack. Further, the method may include applying a first voltage level across the microchannel plates stack during an ionization mode. The first voltage level may be applied by biasing the first face to a higher negative potential relative to a second face. Furthermore, the method may include generating photoelectrons within channels of the microchannel plates stack in response to the applied ultraviolet photons. In addition, the method may include amplifying the generated photoelectrons within the plurality of channels and accelerating the amplified secondary electrons towards an ion trap. Further, the method may include emitting the amplified secondary electrons from the second face of the microchannel plates stack into the ion trap. The amplified secondary electrons may be emitted to ionize sample molecules within the ion trap and accumulate ions in the ion trap. Furthermore, the method may include switching from the ionization mode to a detection mode by changing a bias condition across the microchannel plates stack. The ionization mode may be switched to the detection mode after accumulation of the ions in the ion trap. In addition, the method may include applying a second voltage level across the microchannel plates stack by biasing the second face to a higher negative potential relative to the first face. The second voltage level may include a polarity opposite to a polarity of the first voltage level. Further, the method may include ejecting the ions from the ion trap towards the second face of the microchannel plates stack in a mass-to-charge dependent temporal sequence. Furthermore, the method may include collecting the ejected ions at the second face to generate primary electrons within the plurality of channels of the microchannel plates stack. In addition, the method may include amplifying the generated primary electrons through the plurality of channels towards the first face. Further, the method may include collecting the amplified secondary electrons at the electrically conductive component. The amplified secondary electrons may be collected to generate an ion-dependent detection signal representative of an ion current as a function of mass-to-charge ratio.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

Features of the disclosed embodiments are illustrated by way of example and not limited in the following Figure(s), in which like numerals indicate like elements, in which:

FIGS. 1A-1C illustrate structural representations depicting an existing Electron Ionization Mass Spectrometry (EI-MS) system with two Micro Channel Plates (MCPs) stacks for an electron generation and an ion detection, according to a prior art;

FIG. 2 illustrates an example schematic diagram representation of an ion trap mass spectrometer assembly with integrated ionization and detection, according to an example;

FIG. 3 illustrates an example structural representation depicting a physical configuration of the ion trap mass spectrometer assembly deploying a microchannel plates stack, according to an example;

FIGS. 4A-4C illustrates example schematic representations depicting operational configurations of the ion trap mass spectrometer assembly operating in the ionization mode and the detection mode, according to an example;

FIG. 5A illustrates an example schematic representation of an operational configuration of the ion trap mass spectrometer assembly depicting a generalized architecture in which the microchannel plates stack operates in the ionization mode, according to an example;

FIG. 5B illustrates an example schematic representation of an operational configuration of the ion trap mass spectrometer assembly depicting an operational directionality and a mode dependent behavior of the microchannel plates stack, according to an example;

FIG. 6 illustrates an example schematic representation of a timing and biasing configuration associated with the ion trap mass spectrometer assembly such as shown in FIGS. 5A-5B, according to an example; and

FIG. 7 illustrates an example flow diagram representation of a method of operating the ion trap mass spectrometer assembly, according to an example.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the examples of the present disclosure so as not to obscure the figures with details that will be readily apparent to those skilled in the art having the benefit of the description herein.

### DETAILED DESCRIPTION

For simplicity and illustrative purposes, the proposed approach and solutions are described by referring mainly to examples and embodiments thereof. In the following description, numerous specific details are set forth in order to provide a thorough understanding of the proposed approach and solutions. It will be readily apparent, however, that the proposed approach and solutions may be practiced without limitation to these specific details. In other instances, some methods and structures readily understood by one of ordinary skill in the art have not been described in detail so as not to unnecessarily obscure the ongoing description. As used herein, the terms “a” and “an” are intended to denote at least one of a particular element, the term “includes” means includes but not limited to, the term “including” means including but not limited to, and the term “based on” means based at least in part on, the term “based upon” means based at least in part upon, and the term “such as” means such as but not limited to. The term “relevant” means closely connected or appropriate to what is being performed or considered.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional modules.

One or more functional elements, such as a control circuit, signal conditioning circuit, biasing circuit, timing circuit, or operating logic, may be described as a “module” or “subsystem.” Such a module and/or a subsystem constitutes a tangible entity configured to perform one or more specific operations associated with operation of the ion trap mass spectrometer assembly, including control of ultraviolet photon emission, biasing of a microchannel plate, switching between ionization and detection modes, and coordination of ion accumulation and ion ejection within an ion trap.

Accordingly, the term module and/or subsystem may be implemented in hardware, firmware, software, or a combination thereof. In one example, a module comprises dedicated electronic circuitry that is permanently configured to generate voltage levels, polarity switching, and timing signals for operating a microchannel plate as an electron source and as an ion detector. In another example, a module comprises programmable circuitry or logic, such as a general-purpose processor, microcontroller, or programmable logic device, which is temporarily configured by stored instructions to control operating parameters including voltage magnitude, polarity, timing intervals, and mode transitions. Accordingly, a module or subsystem encompasses physically constructed circuitry that is either permanently configured or dynamically configured to operate in a manner described herein and to perform one or more functions associated with ionization, ion detection, or mass analysis in the ion trap mass spectrometer assembly.

Unless otherwise defined, all technical and scientific terms used herein have the same meaning as commonly understood by those skilled in the art to which this disclosure belongs. The system, methods, and examples provided herein are only illustrative and not intended to be limiting.

A dual-function ion trap mass spectrometer assembly with integrated ionization and detection, and a method thereof may be described. In the following description, for the purposes of explanation, numerous specific details are set forth to provide a thorough understanding of the present disclosure. It is apparent, however, that the present disclosure may be practiced without these specific details or with an equivalent arrangement. In other instances, well-known structures and devices are shown in block diagram form in order to avoid unnecessarily obscuring the present disclosure.

Examples of the present disclosure provide a dual-function ion trap mass spectrometer assembly with integrated ionization and detection, and a method thereof. The ion trap mass spectrometer assembly may include a light source, a microchannel plates stack, an electrically conductive component, an ion trap, and a control circuit. The light source may be configured to emit ultraviolet photons. The microchannel plates stack may include a first face opposite to a second face and a plurality of channels. The plurality of channels may extend between the first face and the second face. The electrically conductive component may be disposed between the light source and the first face of the microchannel plates stack. Further, the electrically conductive component may be configured to transmit at least a portion of the ultraviolet photons toward the microchannel plates stack. Furthermore, the electrically conductive component may be configured to collect electrons exiting the microchannel plates stack. The ion trap may be disposed adjacent to the second face of the microchannel plates stack. The control circuit may be configured to operate the microchannel plates stack in at least one of an ionization mode and a detection mode. The microchannel plates stack may act as an electron source during the ionization mode. Further, the microchannel plates stack may act as an ion detector during the detection mode.

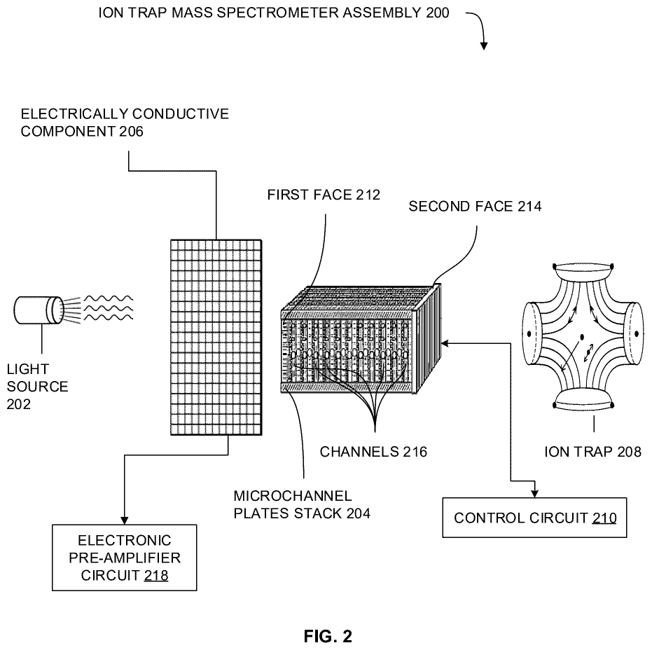

Referring now to the drawings, and more particularly to FIG. 2 through FIG. 7, where similar reference characters denote corresponding features consistently throughout the figures, there are shown preferred examples, and these examples are described in the context of the following exemplary system and/or method.

FIG. 2 illustrates an example schematic diagram representation of an ion trap mass spectrometer assembly 200 with integrated ionization and detection, according to an example. The ion trap mass spectrometer assembly 200 may include a light source 202, a microchannel plates stack 204, an electrically conductive component 206, an ion trap 208, a control circuit 210, and an electronic pre-amplifier circuit 218. The microchannel plates stack 204 may include a first face 212 opposite to a second face 214, and a plurality of channels 216. The plurality of channels 216 may be extending between the first face 212 and the second face 214.

In an example, the control circuit 210 may be connected to the microchannel plates stack 204. Further, the electronic pre-amplifier circuit 218 may be connected to the electrically conductive component 206.

In an example, the ion trap mass spectrometer assembly 200 may refer to an integrated mass spectrometry system. The integrated mass spectrometry system may be configured to perform at least one of an ionization, an ion trapping, a mass-to-charge analysis, and an ion detection using a shared set of components. The ion trap mass spectrometer assembly 200 may include the light source 202 to emit ultraviolet photons, the microchannel plates stack 204, the electrically conductive component 206 disposed between the light source 202 and the microchannel plates stack 204. Further, the ion trap mass spectrometer assembly 200 may include the ion trap 208 positioned adjacent to the microchannel plates stack 204. Furthermore, the ion trap mass spectrometer assembly 200 may include the control circuit 210 to selectively operate the microchannel plates stack 204 in an ionization mode and a detection mode by applying a plurality of voltage levels and a plurality of polarities. For example, the microchannel plates stack 204 may act as an electron source during the ionization mode to ionize sample molecules within the ion trap 208. Further, the microchannel plates stack 204 may act as an ion detector during the detection mode. The microchannel plates stack 204 may be configured to generate an ion-dependent detection signal from ions ejected from the ion trap 208. The ion trap mass spectrometer assembly 200 may be arranged as a compact and linear ion optics stack suitable for at least one of a portable spectrometer system and/or a handheld mass spectrometer system.

In an example, the light source 202 may refer to a radiation emitting device. The radiation emitting device may be configured to generate an electromagnetic radiation suitable for initiating an electron emission within the ion trap mass spectrometer assembly 200. The light source 202 may emit an ultraviolet radiation having a sufficient photon energy to induce a photoelectron generation when incident on at least one of the microchannel plates stack 204 and/or an electron emissive surface. For example, the light source 202 may include, such as, but not limited to, one or more ultraviolet Light Emitting Diodes (LEDs), one or more ultraviolet laser diodes, and/or one or more solid state ultraviolet emitters. The light source 202 may be arranged in a manner to illuminate a selected surface area of the microchannel plates stack 204. The light source 202 may operate in at least one of a continuous mode and/or a pulsed mode under an electronic control. The continuous mode may refer to an operating mode in which the light source 202 may emit an electromagnetic radiation in a substantially uninterrupted manner to provide a steady photon flux for the photoelectron generation. The pulsed mode may refer to an operating mode in which the light source 202 may emit an electromagnetic radiation in a plurality of discrete pulses separated by a plurality of non-emission intervals, with a pulse timing controlled to regulate the photoelectron generation. Further, the light source 202 may be selected to provide at least one of a controlled photon flux, a wavelength, and a timing characteristics appropriate for the ionization mode within the ion trap mass spectrometer assembly 200.

In an example, the microchannel plates stack 204 may refer to an electron-multiplying structure. The microchannel plates stack 204 may be configured to interact with at least one of the ultraviolet photons, electrons, and the ions within the ion trap mass spectrometer assembly 200. The microchannel plates stack 204 may include, such as, for example, but not limited to, the first face 212, the second face 214 and the plurality of channels 216 extending there between. Each of the plurality of channels 216 may include an electron emissive interior surface. The electron emissive interior surface of the plurality of channels 216 may generate and amplify the electrons. For example, the microchannel plates stack 204 may operate as the electron source during the ionization mode in response to an ultraviolet irradiation. The microchannel plates stack 204 may operate as the ion detector during the detection mode by generating secondary electrons in response to incident ions.

In an example, the electrically conductive component 206 may be at least one of a planar conductive structure and/or a semi-planar electrically conductive structure. The planar conductive structure and/or the semi-planar electrically conductive structure may be configured to allow transmission of the ultraviolet radiation and provide a charge collection surface. The electrically conductive component 206 may be at least one of an ultraviolet transparent, a partially ultraviolet transparent, and/or an ultraviolet opaque. Further, the electrically conductive component 206 may be capable of collecting electrons. Furthermore, the electrically conductive component 206 may allow a transmission of at least a portion of incident ultraviolet photons. The electrically conductive component 206 may be configured to transmit ultraviolet radiation. Further, the electrically conductive component 206 may provide an electrically conductive surface for a charge collection. For example, the electrically conductive component 206 may include, such as, for example, but not limited to, a conductive mesh, a perforated membrane, a thin conductive film and/or a grid electrode. The conductive mesh may be formed of at least one of metal wires and/or traces arranged to define a plurality of apertures. The plurality of apertures may permit the ultraviolet photons to pass therethrough. The perforated conductive membrane may include a thin substrate with an array of through-holes and a conductive coating. The thin conductive film may deposited on an ultraviolet transparent substrate, such as, for example, but not limited to, quartz and/or sapphire, with a plurality of patterned openings and/or a partial transparency. The grid electrode may be positioned between the light source 202 and the microchannel plates stack 204. Further, the grid electrode may be electrically biased to collect the electrons emitted from the microchannel plates stack 204. The electrically conductive component 206 may include a plurality of apertures. The plurality of apertures may permit the ultraviolet photons to pass toward the microchannel plates stack 204. Further, the plurality of apertures may provide a collection of at least one of the electrons and/or a charge signal generated during a mass spectrometer operation within the ion trap mass spectrometer assembly 200.

In an example, the ion trap 208 may refer to an electrode structure. The ion trap 208 may be configured to receive, confine, and selectively eject ions using controlled electric fields. The ion trap 208 may define a trapping region in which ions may be accumulated prior to mass analysis. For example, the ion trap 208 may include, such as, but not limited to, a quadrupole ion trap, a linear ion trap, and/or other electrode configurations. The ion trap 208 may be configured to temporally control ion motion and ejection as a function of mass-to-charge ratio. The quadrupole ion trap may refer to an ion confinement structure. Further, the ion confinement structure may include a ring electrode and a pair of endcap electrodes. The ion confinement structure may be configured to generate a three dimensional quadrupole electric field. Further, an applied Radio Frequency (RF) signal and an optional Direct Current (DC) voltage may confine the ions within a central trapping region. Further, the applied Radio Frequency (RF) signal and the optional Direct Current (DC) voltage may selectively destabilize ion trajectories to eject the ions as the function of mass-to-charge ratio during the mass analysis operation. The linear ion trap may refer to the ion confinement structure including a plurality of elongated electrodes arranged to generate a quadrupole electric field along a longitudinal axis. Further, the ions may be trapped radially by radio frequency fields. Furthermore, the ions may be confined axially by end electrodes and/or axial potentials. For example, the ions may be accumulated along a length of a trap and sequentially ejected in a mass to charge dependent manner. Further, the other electrode configurations may refer to ion trapping structures applying alternative electrode geometries and/or field arrangements capable of confining and manipulating the ions. Furthermore, the other electrode configurations may include cylindrical ion traps, rectilinear ion traps, toroidal ion traps, planar ion traps, and/or one or more segmented electrode arrangements, in which electric fields may be generated to trap, accumulate, and selectively eject the ions for a mass analysis.

In an example, the control circuit 210 may refer to an electronic circuitry. The electronic circuitry may be configured to coordinate operation of one or more components of the ion trap mass spectrometer assembly 200. The control circuit 210 may generate, apply, and switch the plurality of voltage levels, the plurality of polarities, and timing signals to control the ionization mode, an ion trapping mode, an ion ejection mode, and the detection mode. For example, the control circuit 210 may include, such as, but not limited to, a fixed-function circuitry, a programmable logic, a microcontroller, and/or one or more processor executing stored instructions. The fixed-function circuitry permanently may be configured to generate a plurality of control signals. The programmable logic may be reconfigurable to apply a plurality of control operations within the ion trap mass spectrometer assembly 200. The microcontroller may be configured to execute firmware for a coordinated system control within the ion trap mass spectrometer assembly 200. The one or more processors executing stored instructions may dynamically manage a plurality of operating modes, timing, and biasing conditions of the ion trap mass spectrometer assembly 200.

In an example, the electronic pre-amplifier circuit 218 may refer to a signal conditioning circuit. The signal conditioning circuit may be configured to receive a plurality of low-level electrical signals generated in response to detected ions. Further, the signal conditioning circuit may be configured to generate an amplified output suitable for further processing. For example, the electronic pre-amplifier circuit 218 may amplify at least one of an ion dependent current and/or a plurality of charge signals collected at an electrically conductive component. Further, the electronic pre-amplifier circuit 218 may provide a plurality of conditioned signals for at least one of a subsequent digitization and/or a generation of a mass spectrum.

In an example, the ion trap mass spectrometer assembly 200 may include the light source 202, the microchannel plates stack 204, the electrically conductive component 206, the ion trap 208, the control circuit 210, and the electronic pre-amplifier circuit 218. The light source 202 may be configured to emit the ultraviolet photons. In an example, the ultraviolet photons may refer to quanta of an electromagnetic radiation with wavelengths shorter than visible light and sufficient photon energy. The ultraviolet photons may induce a photoelectric emission from an electron emissive surface. For example, the ultraviolet photons may include, such as, but not limited wavelengths in a range from, about 10 nanometers to about 400 nanometers. The wavelengths may include such as, for example, but not limited to, an ultraviolet-C radiation, an ultraviolet-B radiation, and/or an ultraviolet-A radiation emitted by the light source 202. The light source 202 may include, such as, for example, but not limited to, an ultraviolet Light Emitting Diode (LED) and/or an ultraviolet laser source. When incident on the microchannel plates stack 204 and/or a photocathode surface, the ultraviolet photons may generate the photoelectrons. The photoelectrons may be subsequently amplified to generate secondary electrons and utilized for the ionization mode within the ion trap mass spectrometer assembly 200. In an example, the light source 202 may include, such as, for example, but not limited to, an Ultraviolet Light Emitting Diode (UV LED). The light source 202 may be configured to emit the ultraviolet photons. The ultraviolet photons may be of a central wavelength of, for example, but not limited to, approximately 255 nanometers. The UV LED may be operated with an optical output power on an order of a few milliwatts. For example, the light source 202 may be operated in, such as, but not limited to, a pulsed mode, and a continuous wave operation mode. In the pulsed mode, a plurality of pulse durations on the order of approximately 12 milliseconds may be applied. Further, the ultraviolet photons incident on the microchannel plates stack 204 may generate a primary photoelectron current at an input of the microchannel plates stack 204. The primary photoelectron current may be on an order of a plurality of sub picoampere levels. Further, the plurality of sub picoampere levels may depend on at least one of the operating mode and one or more surface characteristics of the microchannel plates stack 204.

The microchannel plates stack 204 may include the first face 212 opposite to the second face 214, and the plurality of channels 216. The plurality of channels 216 may include extending between the first face 212 and the second face 214. The electrically conductive component 206 may be disposed between the light source 202 and the first face 212 of the microchannel plates stack 204. In an example, the secondary electrons emitted from the microchannel plates stack 204 during the ionization mode may form at least one broad and flood type secondary electron distribution. Then at least one broad and flood type electron distribution may be directed toward the ion trap 208. For example, a distribution of the secondary electrons may be injected into the ion trap 208 without using one or more additional focusing elements. The one or more additional focusing elements may refer to at least one of an electrostatic lens, an einzel lens, a focusing electrode, a deflection electrode, a steering plate, and/or one or more electron-optical structures. Further, the one or more additional focusing elements may be configured to shape, collimate, and/or direct a distribution of the secondary electrons toward the ion trap 208. The secondary electrons may be injected into the ion trap 208 such that the secondary electrons may be guided primarily by electric fields. The electric fields guiding the secondary electrons may be established between the microchannel plates stack 204 and the ion trap 208. For example, one or more guiding structures may be provided to at least shape and/or direct the distribution of the secondary electrons toward an entrance region of the ion trap 208 during the ionization mode. The one or more guiding structures may include, such as, for example, but not limited to, one or more electrostatic lenses and/or one or more additional biasing electrodes. Further, at least one of a lens-less injection configuration and a lensed injection configuration may be applied depending on at least one of a structural objective and the operating mode of the ion trap mass spectrometer assembly 200.

The electrically conductive component 206 may be configured to transmit at least a portion of the ultraviolet photons toward the microchannel plates stack 204. Further, the electrically conductive component 206 may be configured to collect electrons exiting the microchannel plates stack 204. In an example, the electrically conductive component 206 may include, such as, for example, but not limited to, a perforated conductive structure and/or a porous conductive structure. The electrically conductive component 206 may be disposed between the light source 202 and the microchannel plates stack 204. The electrically conductive component 206 may include, such as, for example, but not limited to, a holey mesh, a membrane, and/or a patterned conductive layer. Further, the electrically conductive component 206 may be configured to permit at least the portion of the ultraviolet photons to reach a surface of the microchannel plates stack 204. The electrically conductive component 206 may further be operable in a partial ultraviolet transparency. The electrically conductive component 206 may further be configured to collect the secondary electrons emitted from the microchannel plates stack 204 during the detection mode. For example, the electrically conductive component 206 may include, such as, but not limited to, a metal mesh, a conductive membrane, and/or a conductive coating formed on a substrate. Further, the electrically conductive component 206 may include, such as, for example, but not limited to, a plurality of apertures and/or a plurality of pores. The plurality of apertures and/or a plurality of pores may be formed with dimensions, which may be selected to balance at least one of a transmission efficiency of the ultraviolet photons and a collection efficiency of the photoelectrons.

The ion trap 208 may be disposed adjacent to the second face 214 of the microchannel plates stack 204. In an example, the microchannel plates stack 204 may include at least two or more microchannel plates may be operated in a manner which may support the ionization mode and the detection mode. For example, the microchannel plates stack 204 may function collectively as an electron source during the ionization mode. Further, the microchannel plates stack 204 may function collectively as the ion detector during the detection mode, based on the plurality of control signals provided by the control circuit 210. The operational mode of the microchannel plates stack 204 may be switched by the control circuit 210 through controlled transitions of voltage polarity and timing, without requiring a fixed assignment of one microchannel plate from the microchannel plates stack 204 to a specific mode. In another example, the ion trap 208 (collectively referred to as a plurality of ion traps 208) may include a modified cylindrical ion trap configuration. The modified cylindrical ion trap configuration may include arranging a plurality of ion traps in an ion trap array. Each of the plurality of ion traps 208 of the ion trap array may include, such as, for example, but not limited to, one or more cylindrical electrodes and/or one or more substantially cylindrical electrodes configured to generate trapping electric fields for confining the ions. For example, the ion trap 208 may be formed with an effective trapping diameter of approximately, such as, for example, but not limited to, 630 micrometers, corresponding to an effective radial dimension (r₀) of approximately, such as, for example, but not limited to, 315 micrometers. Further, the plurality ion traps 208, for example on an order of about 180 ion traps, may be integrated into the ion trap array formed on a common substrate. The ion trap array may occupy an overall chip area of approximately, such as, for example, but not limited to, 17 millimeters by 17 millimeters. Further, a plurality of other dimensions and a plurality of trap counts may be used depending on at least one of a structural requirement and an application requirement of the ion trap mass spectrometer assembly 200. The modified cylindrical ion trap configuration may be selected to provide at least one of a compact integration, a scalable array formation, and an efficient coupling with the microchannel plates stack 204 for the ionization mode and the detection mode within the ion trap mass spectrometer assembly 200. In another example, the ion trap 208 may be operated using the applied Radio Frequency (RF) signal. The applied RF signal may be configured with a frequency of approximately, such as, for example, but not limited to, 9 megahertz (MHz). Further, the ion trap 208 may be configured to generate the trapping electric fields for the ion confinement. Further, each of one or more supplementary Alternating Current (AC) voltages and the optional Direct Current (DC) voltage, may be supplied with amplitudes on an order of a few volts. Further, each of the one or more supplementary AC voltages and the one or more DC voltages may be applied to one or more selected electrodes of the ion trap 208 to enhance a mass elective ion stability. Furthermore, each of the one or more supplementary AC voltages and the one or more DC voltages improve a mass resolution during a mass analysis scan. The ion trap mass spectrometer assembly 200 may be configured to analyze the ions over a mass to charge (m/z) range. The mass to charge range may be from about, such as, for example, but not limited to, 28 atomic mass units (amu) to about 210 amu. The ion trap 208 may further be configured to achieve a mass resolution of approximately 1 amu over a lower mass range from about, such as, for example, but not limited to, 28 amu to about 100 amu. Further, the ion trap 208 may further be configured to achieve another mass resolution of approximately, such as, for example, but not limited to, 1.5 amu to about 1.75 amu over a higher mass range from about, such as, for example, but not limited to, 100 amu to about 200 amu. The higher mass range resolution may be measured using a full width at half maximum criterion.

In another example, the ions may be axially ejected from the ion trap 208 toward the microchannel plates stack 204 during the detection mode. The axial ejection may be performed using, such as, for example, but not limited to, a mass selective instability operating mode and a resonance ejection technique. In the resonance ejection technique, a supplementary excitation signal may be applied to the one or more selected electrodes of the ion trap 208 to selectively destabilize the ions according to a mass-to-charge ratio. For example, the resonance ejection technique may be omitted, and an ion ejection may be performed using the mass selective instability mode without a resonance excitation. Further, the ions ejected from the ion trap 208 may be directed toward the microchannel plates stack 204 without requiring at least one of one or more additional focusing electrodes and/or one or more steering electrodes disposed between the ion trap 208 and the microchannel plates stack 204 during the detection mode.

The control circuit 210 may be configured to operate the microchannel plates stack 204 in at least one of the ionization mode and the detection mode. The microchannel plates stack 204 may act as an electron source during the ionization mode. The microchannel plates stack 204 may act as the ion detector during the detection mode. In an example, the ionization mode may refer to an operating state of the ion trap mass spectrometer assembly 200 in which the microchannel plates stack 204 may be biased. Further, the microchannel plates stack 204 may be illuminated to generate the electrons for one or more ionizing sample molecules. For example, during the ionization mode, the ultraviolet photons may impinge on the first face 212 of the microchannel plates stack 204 to generate the secondary electrons. The secondary electrons may be amplified within the plurality of channels 216 generating secondary electrons. Further, these secondary electrons may be emitted toward the ion trap 208 to create the ions from one or more neutral molecules. In another example, the detection mode may refer to an operating state of the ion trap mass spectrometer assembly 200. Further in the detection mode, the microchannel plates stack 204 may be biased to receive the ions and generate a measurable electrical signal. For example, during the detection mode, the ions ejected from the ion trap 208 may strike the second face 214 of the microchannel plates stack 204 to generate the primary electrons. These primary electrons may be amplified through the plurality of channels 216 generating secondary electrons. Further, the secondary electrons may be collected to generate the ion-dependent detection signal. In another example, the electron source may refer to at least one of a structure and/or a device. The electron source may be configured to emit the electrons in response to an applied stimulus. For example, the microchannel plates stack 204 may act as the electron source when the ultraviolet photons incident on the microchannel plates stack 204 may generate the photoelectrons. The generated photoelectron may be amplified generating secondary electrons and emitted for ionization of the one or more ionizing sample molecules. In another example, the ion detector may refer to at least one of a structure and/or a device. The ion detector may be configured to receive the ions and convert ion impacts into an electrical signal. For example, the microchannel plates stack 204 may act as the ion detector by generating the primary electrons in response to the incident ions. The microchannel plates stack 204 may be configured to amplify the primary electrons within the plurality of channels 216 thereby generating secondary electrons. Further, the microchannel plates stack 204 may be configured to generate a detectable output signal representative of an ion arrival within the ion trap mass spectrometer assembly 200.

In an example, the ion trap mass spectrometer assembly 200 may include one or more microchannel plates. The one or more microchannel plates may include, such as, for example, but not limited to, the microchannel plates stack 204 arranged in a stacked configuration. The stacked configuration may include, such as, for example, but not limited to, a chevron configuration and a z-stack configuration. The chevron configuration may include, such as, for example, but not limited to, at least two microchannel plates. The z-stack configuration may include, such as, for example, but not limited to, at least three microchannel plates. Further, the chevron configuration and the z-stack configuration may be selected to provide at least one of an increased electron gain and an ion detection sensitivity. For example, each of the one or more microchannel plates may include a plurality of channels. The plurality of channels may be formed with at least one of a pore diameter, a bias angle, and/or a Length to Diameter (L/D) ratio. The pore diameter may be formed with approximately, such as, for example, but not limited to, 12 micrometers (μm). The bias angle may be approximately of, such as, for example, but not limited to, 8 degrees. The Length to Diameter (L/D) ratio may be approximately of, such as, for example, but not limited 40. The one or more microchannel plates may be formed from, such as, for example, but not limited to, a lead glass material and/or an electron emissive substrate. Further, the one or more microchannel plates may be coated with, such as, for example, but not limited to, a surface coating. The surface coating may enhance at least one of a plurality of electron emission characteristics and an operational lifetime of the one or more microchannel plates. Further, one or more other materials and one or more surface coatings may be applied to the one or more microchannel plates.

In another example, the ion trap mass spectrometer assembly 200 may include the light source 202. The light source 202 may be configured to emit the ultraviolet photons toward the microchannel plates stack 204. The microchannel plates stack 204 may include the plurality of channels 216 configured to amplify the photoelectrons. The electrically conductive component 206 may be disposed between the light source 202 and the microchannel plates stack 204. Further, the electrically conductive component 206 may be configured to transmit the ultraviolet photons toward the microchannel plates stack 204. The electrically conductive component 206 may collect the secondary electrons generated by the microchannel plates stack 204. The ion trap 208 may be configured to receive the secondary electrons emitted from the microchannel plates stack 204 during the ionization mode. Further, the ion trap 208 may be configured to eject the ions toward the microchannel plates stack 204 during the detection mode. For example, the electronic pre-amplifier circuit 218 may be coupled to the electrically conductive component 206 to amplify at least one of an electron-dependent signal and the ion-dependent detection signal. The ion trap mass spectrometer assembly 200 may include the one or more microchannel plates. The one or more microchannel plates may include, such as, for example, but not limited to, the microchannel plates stack 204. Further, the one or more microchannel plates may be arranged in a stacked configuration. Each of the one or more microchannel plates may include a first face opposite to a second face. Further, the microchannel plates stack 204 may include the plurality of channels 216. The plurality of channels 216 may be formed with diameters lying within a range from, for example, such as, but not limited to, about 0.1 micrometer (μm) to about 100 μm. The electrically conductive component 206 may include a membrane coated with at least one of a conductive metal layer and a conductive mesh. Further, the conductive mesh may include a plurality of pores. The plurality of pores may be formed with diameters in a range from, such as, for example, but not limited to, about 0.01 μm to about 1000 μm. In one example, the light source 202 may be configured to emit the ultraviolet photons having a representative central wavelength of approximately 255 nanometers. Further, the light source 202 may further be operated in at least one of a continuous mode and a pulsed mode, depending on an operating configuration of the ion trap mass spectrometer assembly 200. The electrically conductive component 206 may include a structure disposed between the light source 202 and the first face 212 of the microchannel plates stack 204. Further, the microchannel plates stack 204 may be configured to allow a transmission of at least a portion of the ultraviolet photons toward the microchannel plates stack 204. Furthermore, the microchannel plates stack 204 also provide a collection of the secondary electrons exiting the microchannel plates stack 204. In some examples, the electrically conductive component 206 may include a mesh structure. The mesh structure may include a relatively high open area fraction to provide a transmission of the ultraviolet photons. For example, the electrically conductive component 206 may include a membrane and/or a substrate, which may be at least one of an ultraviolet transparent and/or a partially ultraviolet transparent. Further, the electrically conductive component 206 may not be formed as a mesh. Furthermore, the electrically conductive component 206 may include an electrically conductive structure. The electrically conductive structure may be optically opaque. Further, the electrically conductive structure may provide a collection of electrons. Furthermore, the electrically conductive structure may permit transmission of at least a portion of the ultraviolet photons through at least one of openings, pores, and/or thin regions of the electrically conductive structure.

In another example, in the ionization mode, the control circuit 210 may be configured to generate the photoelectrons within the plurality of channels 216 of the microchannel plates stack 204 using the ultraviolet photons by applying a first voltage level across the first face 212 of the microchannel plates stack 204 relative to the second face 214. The control circuit 210 may be configured to amplify the generated photoelectrons. In an example, during the ionization mode, the photoelectrons may be generated within the plurality of channels 216 of the microchannel plates stack 204 in response to the ultraviolet photons. For example, the ultraviolet photons may be characterized by a representative wavelength of approximately 255 nanometers, which may be incident on a surface of the microchannel plates stack 204. Further, generation of the photoelectrons may occur due to a photoelectric effect associated with a work function of a material of the microchannel plates stack 204. Furthermore, an amplification of the generated photoelectrons may be achieved by application of a first voltage level across the microchannel plates stack 204, such that a potential difference may be established between the first face 214 and the second face 216 of the microchannel plates stack 204. The applied first voltage level may further accelerate the amplified secondary electrons toward the ion trap 208 for ionization of the sample molecules within the ion trap 208. Further, the control circuit 210 may be configured to accelerate the amplified secondary electrons towards the ion trap 208. Furthermore, the control circuit 210 may be configured to emit the amplified secondary electrons from the second face 214 of the microchannel plates stack 204 towards the ion trap 208. The amplified secondary electrons may be emitted towards the ion trap 208 to ionize sample molecules within the ion trap 208. In an example, the sample molecules may be introduced into a vacuum chamber (not depicted in FIG. 2) of the ion trap mass spectrometer assembly 200 using one or more sample introduction mechanisms. The one or more sample introduction mechanisms may include, such as, for example, but not limited to, a pulsed valve and/or a capillary leak. Further, the one or more sample introduction mechanisms may be configured to admit the sample molecules into the ion trap 208. For example, a membrane based inlet may be applied to allow a selective permeation of the sample molecules into the vacuum chamber. The membrane based inlet may include, such as, for example, but not limited to, a polymeric membrane. The polymeric membrane may be manufactured from, such as, for example, but not limited to, a polydimethylsiloxane (PDMS) material. The ion trap mass spectrometer assembly 200 may be configured for at least one of a continuous sampling, a pulsed sampling, and/or an ambient sampling. The at least one of the continuous sampling, the pulsed sampling, and/or the ambient sampling may depend on at least one of an operating mode and a selected sample introduction mechanism. The operating mode may include, such as, for example, but not limited to, the ionization mode and the detection mode. The selected sample introduction mechanism may refer to at least one of a structure and/or a device. Further, the selected sample introduction mechanism may be configured to admit the sample molecules into the vacuum chamber of the ion trap mass spectrometer assembly 200. Furthermore, the selected sample introduction mechanism may be configured to determine whether sampling may be performed in at least one of a continuous manner, a pulsed manner, and/or an ambient manner. In another example, the ion trap mass spectrometer assembly 200 may be configured to operate within the vacuum chamber. The vacuum chamber may be configured with a reduced internal volume. Further, the reduced internal volume of the vacuum chamber may provide a pump down time on an order of, such as, for example, but not limited to, less than approximately one minute when coupled to a suitable vacuum pump. Further, one or more pump down characteristics may be indicative of a compact configuration of the ion trap mass spectrometer assembly 200. Furthermore, at least one of a vacuum tolerance, one or more operating pressure ranges, and the pump down time of the vacuum chamber may vary depending on at least one of a system configuration, a pump selection, and one or more deployment conditions of the ion trap mass spectrometer assembly 200.

In another example, in the detection mode, the control circuit 210 may be configured to apply a second voltage level across the second face 214 of the microchannel plates stack 204. The second voltage level may include a polarity opposite to a polarity of the first voltage level. The control circuit 210 may be configured to collect ions ejected from the ion trap 208 towards the second face 214 to generate the primary electrons within the plurality of channels 216 of the microchannel plates stack 204 upon applying the second voltage level. Further, the control circuit 210 may be configured to amplify the generated primary electrons. The primary electrons may thereby be generating the secondary electrons through the plurality of channels 216 and accelerating the secondary electrons toward the first face 212. Furthermore, the control circuit 210 may be configured to collect the amplified secondary electrons at the electrically conductive component 206 to generate the ion-dependent detection signal. In an example, during the detection mode, the control circuit 210 may apply one or more voltage levels to the microchannel plates stack 204. The applied voltage polarity may be inverted relative to the voltage polarity applied during the ionization mode. Further, an inversion of the voltage polarity may provide an ion collection and conversion to primary electrons at the second face 214 of the microchannel plates stack 204 facing the ion trap 204. Furthermore, the inversion of the voltage polarity may provide generation of the secondary electrons within the plurality of channels 216. In addition, the inversion of the voltage polarity may provide amplification of the secondary electrons. Further, the inversion of the voltage polarity may provide collection of the amplified secondary electrons at the electrically conductive component 206 to generate the ion-dependent detection signal.

In another example, the ion trap mass spectrometer assembly 200 may include the electronic pre-amplifier circuit 218. The electronic pre-amplifier circuit 218 may be connected to the electrically conductive component 206. The electronic pre-amplifier circuit 218 may be configured to amplify the ion-dependent detection signal collected at the electrically conductive component 206.

In another example, the light source 202 may include at least one ultraviolet light emitting diode. Then at least one ultraviolet light emitting diode may be arranged to illuminate a surface area of the microchannel plates stack 204 corresponding to the plurality of channels 216.

In another example, the microchannel plates stack 204 may include at least one of a single plate and two or more plates arranged in a stacked configuration. Each of the plurality of channels 216 of the microchannel plates stack 204 may include a diameter in a range from 0.1 μm to 100 μm.

In another example, the electrically conductive component 206 may include a membrane coated with at least one of a conductive metal layer and a conductive mesh. The conductive mesh may include a plurality of pores of diameters in a range from 0.01 μm to 1000 μm. For example, the membrane coated with the conductive metal layer may be ultraviolet transparent. The conductive mesh may be configured with at least one of a plurality of openings and/or the plurality of pores. Further, the conductive mesh may not be fully ultraviolet transparent. However, the conductive mesh may be sufficiently open and/or holey to allow transmission of at least a portion of the ultraviolet photons toward the microchannel plates stack 204 to provide a collection of electrons.

In another example, the ion trap 208 may include a quadrupole ion trap. The quadrupole ion trap may include an annular plate electrode. The annular plate electrode may be configured to admit the electrons emitted from the second face 214 of the microchannel plates stack 204 into a central trapping region of the ion trap 208.

In another example, the first voltage level biases the first face 212 of the microchannel plates stack 204 to a higher negative potential relative to the second face 214. The second face 214 may be configured with at least one of a ground potential and a low negative voltage level to accelerate the generated secondary electrons towards the ion trap 208. The low negative voltage level may lie within a range of, such as, for example but not limited to, a range of approximately 10 volts to 100 volts. In an example, one or more bias voltages applied across the microchannel plates stack 204 may correspond to the first voltage level in which a surface of the microchannel plates stack 204 facing the light source 202 may be biased to the higher negative potential relative to a surface facing the ion trap 208 during the ionization mode. In the second voltage level, a polarity opposite to the polarity of the first voltage level may be reversed during the detection mode. For example, a magnitude of the one or more bias voltages may be applied on an order of kilovolts, such as, for example, but not limited to, approximately −2 kilovolts. Further, an opposing surface of the microchannel plates stack 204 may be configured at and/or near a ground potential. The control circuit 210 may be configured to switch between the first voltage level and the second voltage level within a time interval of approximately, such as, for example, but not limited to, 0.5 milliseconds. Further one or more other switching intervals may also be used. For example, a voltage switching may be implemented using at least one of an external power supply and/or a laboratory power supply during a characterization of the ion trap mass spectrometer assembly 200. Further, in some examples, the voltage switching may be implemented using at least one dedicated high voltage switching circuitry. Then at least one dedicated high voltage switching circuitry may include, such as, for example, but not limited to, a plurality of solid-state switching devices. Then at least one dedicated high voltage switching circuitry may be configured to control one or more bias transitions. Further, the at least one dedicated high voltage switching circuitry may be configured to mitigate an electrical arcing within the ion trap mass spectrometer assembly 200.

In another example, the second voltage level biases the second face 214 of the microchannel plates stack 204 to a higher negative potential relative to the first face 212. The first face 212 may be configured with at least one of a ground potential and a low negative potential. The ions impinging on the second face 214 of the microchannel plates stack 204 may generate primary electrons. The primary electrons which may then be accelerated and amplified toward the electrically conductive component 206. The low negative voltage level may lie within a range of, such as, for example but not limited to, a range of approximately 10 volts to 100 volts.

In another example, the first voltage level may include a potential difference across the microchannel plates stack 204. The potential difference may lie within a range of about 500 V to about 1 kV per microchannel plate. Further, the potential difference may lie within a range of about 1 kV to about 3 kV across the microchannel plates stack 204. The microchannel plates stack 204 may include at least two microchannel plates. In an example, the microchannel plates stack 204 may include at least two or more microchannel plates arranged in a stacked configuration. Further, the stacked configuration may include a two plate (chevron-stack) configuration and a three plate (Z-stack) configuration. Further, each of the two-plate chevron configuration and the three-plate configuration may be configured to provide an increased electron gain relative to a microchannel plate of the microchannel plates stack 204.

In another example, the second voltage level may include a potential difference across the microchannel plates stack 204. The potential difference may lie within a range of about 500 V to about 1 kV per microchannel plate. Further, the potential difference may lie a range of about 1 kV to about 3 kV across the microchannel plates stack 204. The microchannel plates stack 204 may include at least two microchannel plates. In another example, the ion trap mass spectrometer assembly 200 may include the vacuum chamber. The vacuum chamber may include enclosing the light source 202, the electrically conductive component 206, the microchannel plates stack 204, and the ion trap 208. The vacuum chamber may be coupled to a vacuum pump. Further, the vacuum chamber may include a reduced internal volume to decrease an initial evacuation time. The reduced internal volume may reduce a pumping capacity requirement relative to a conventional ion trap mass spectrometer.

In another example, the light source 202, the electrically conductive component 206, the microchannel plates stack 204, and the ion trap 208 may be configured as a compact mass spectrometer engine. For example, the electrically conductive component 206, the microchannel plates stack 204, and the ion trap 208 may be arranged along a common axis to form a linear ion-optics stack. In some examples, the electrically conductive component 206, the microchannel plates stack 204, and the ion trap 208 may be arranged in a nonlinear configuration, including at least one of an angled path, a folded path, and/or an orthogonal ion optical path, without departing from a functional operation of the ion trap mass spectrometer assembly 200. The compact mass spectrometer engine may be dimensioned for integration into at least one of a handheld mass spectrometer housing and a portable mass spectrometer housing and/or a benchtop mass spectrometer system.

In another example, the control circuit 210 may further be configured to operate at least one of the microchannel plates stack 204 as an electron source and an ion detector.

In another example, the ion trap 208 may be configured to eject ions selectively and symmetrically towards one microchannel plate of the microchannel plates stack 204. In an example, the ion trap mass spectrometer assembly 200 may include the ion trap 208. The ion trap 208 may be a symmetrical ion trap. The ion trap 208 may include one or more opposing ejection directions. Further, in an example configuration, the microchannel plates stack 204 may be disposed on opposite sides of the ion trap 208. Furthermore, in the example configuration, each of the microchannel plates stack 204 may be selectively operable as an electron source during the ionization mode and as the ion detector during the detection mode. Therefore, in the example configuration, at least one of an overall ionization efficiency and an ion detection efficiency of the ion trap mass spectrometer assembly 200 may be increased. For example, the microchannel plates stack 204 may differ in a plurality of amplification characteristics. The microchannel plates stack 204 may include, such as, for example, but not limited to, one microchannel plate. The microchannel plates stack 204 may provide a single plate configuration. Further, the microchannel plates stack 204 may provide a stacked (z-stack) configuration. Furthermore, the microchannel plates stack 204 may provide an increased dynamic range for the ion detection. In another example, when the ion trap 208 may be symmetric, the microchannel plates stack 204 may be disposed on opposite sides of the ion trap 208. Further, an operation of the microchannel plates stack 204 may be temporally coordinated by the control circuit 210. For example, an ionization interval may be followed by a detection interval at one or both ends of the ion trap 208 after at least one of a quench and/or delay period. The quench and/or delay period may be on an order of approximately, such as, for example, but not limited to, one millisecond, for a timing and biasing configuration associated with the ion trap mass spectrometer assembly 200. Further, one or more performance characteristics of a dual microchannel plate configuration relative to a single microchannel plate configuration may be evaluated empirically. The dual microchannel plate configuration may include the microchannel plates stack 204. The single microchannel plate configuration may include the microchannel plates stack 204. The microchannel plates stack 204 may simplify a structure of the ion trap mass spectrometer assembly 200. Further, the microchannel plates stack 204 may reduce a count of the one or more components of the ion trap mass spectrometer assembly 200.

In another example, the microchannel may act as the electron source during the ionization mode for a first-time interval. The ion trap 208 may be configured to accumulate ions generated by electrons emitted from the second face 214. The microchannel plates stack 204 may act as the ion detector during the detection mode for a second time interval subsequent to the first-time interval. The ion trap 208 may be configured to eject the ions towards the second face 214. The control circuit 210 may be configured to switch the microchannel plates stack 204 between the ionization mode and the detection mode based on at least one parameter. Then at least one parameter may include an elapsed ionization time corresponding to a target ion accumulation period, a measured ion population level within the ion trap 208, a mass-analysis scan trigger from an external controller, and a monitored pressure and an operating condition within the vacuum chamber.

In another example, the control circuit 210 may be configured to terminate the first voltage level and apply the second voltage level in response to a control signal indicating completion of ion accumulation. The control circuit 210 may be configured to terminate the second voltage level and re-apply the first voltage level after completion of a mass-to-charge scan of the ion trap 208.

In another example, the control circuit 210 may include a high voltage switching network (not depicted in FIG. 2). The high voltage switching network may be configured to selectively apply opposite voltage polarities across the first face 212 and the second face 214 of the microchannel plates stack 204. The high voltage switching network may include at least one solid state high voltage switch. Then at least one solid state high voltage switch may be configured to reverse the voltage polarity applied to the microchannel plates stack 204 without mechanical reconfiguration.

In another example, the control circuit 210 may be configured to maintain the microchannel plates stack 204 at a substantially constant gain during the ionization mode and the detection mode.

In another example, during the ionization mode, the ultraviolet photons incident on inner surfaces of the plurality of channels 216 of the microchannel plates stack 204 generate the photoelectrons multiplied by secondary emission within the plurality of channels 216. The multiplied secondary electrons may exit the second face 214 of the microchannel plates stack 204 with sufficient kinetic energy to ionize neutral molecules within the ion trap 208 by electron impact.

In another example, during the detection mode, the ions impinging on the second face 214 of the microchannel plates stack 204 generate primary electrons from channel walls by an ion induced secondary emission. The generated primary electrons may be multiplied within the plurality of channels 216. The generated secondary electrons may exit the first face 212 of the microchannel plates stack 204 toward the electrically conductive component 206.

In another example, the control circuit 210 may be configured to electrically isolate the ion trap 208 from the microchannel plates stack 204 during voltage polarity transitions to avoid at least one of an uncontrolled ion and/or an electron motion. Further, the control circuit 210 may be configured to enforce a dead time interval between the ionization mode and the detection mode to allow stabilization of electric fields within the ion trap 208. Furthermore, the control circuit 210 may be configured to adjust the applied voltage magnitude across the microchannel plates stack 204 independently in the ionization mode and the detection mode. The adjustment of the applied voltage magnitude may be used to control electron gain and dynamic range during ion detection. In addition, the control circuit 210 may be configured to operate the microchannel plates stack 204 in the ionization mode.

In another example, the ionization mode and the detection mode may be mutually exclusive and temporally separated to avoid at least one of a simultaneous electron emission and an ion detection.

In another example, the electrically conductive component 206 may be biased to collect the secondary electrons exiting the first face 212 of the microchannel plates stack 204 during the detection mode. Further, the electrically conductive component 206 may function as an anode of the microchannel plates stack 204 during the detection mode.

In another example, the electronic pre-amplifier circuit 218 may be configured to convert collected electron charge into a voltage signal representative of ion abundance.

In another example, the ion trap mass spectrometer assembly 200 may be applied in a plurality of application domains. The plurality of application domains may include, such as, for example, but not limited to, a portable detection of one or more explosives agents and one or more chemical warfare agents, an environmental monitoring, and a breath and/or biological analysis and the like. Further, the ion trap mass spectrometer assembly 200 may be configured to detect and analyze a broad range of chemical species. The broad range of chemical species may include, such as, for example, but not limited to, one or more volatile organic compounds (VOCs) and one or more semi volatile organic compounds (semi-VOCs).

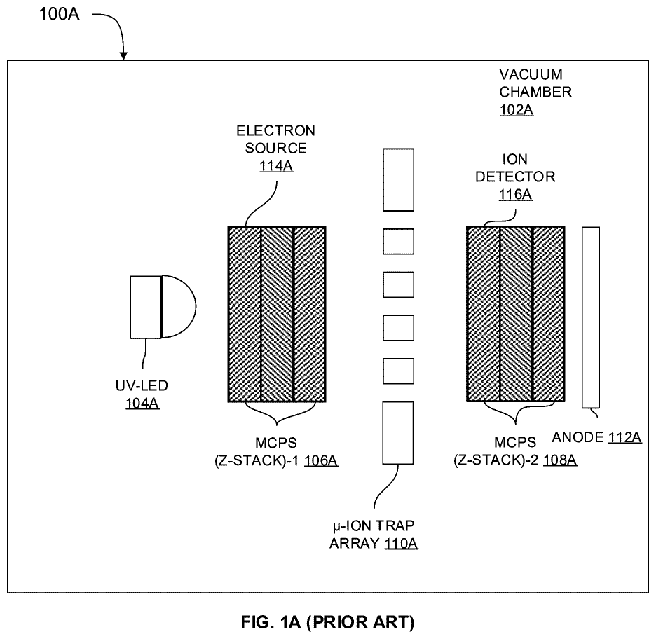

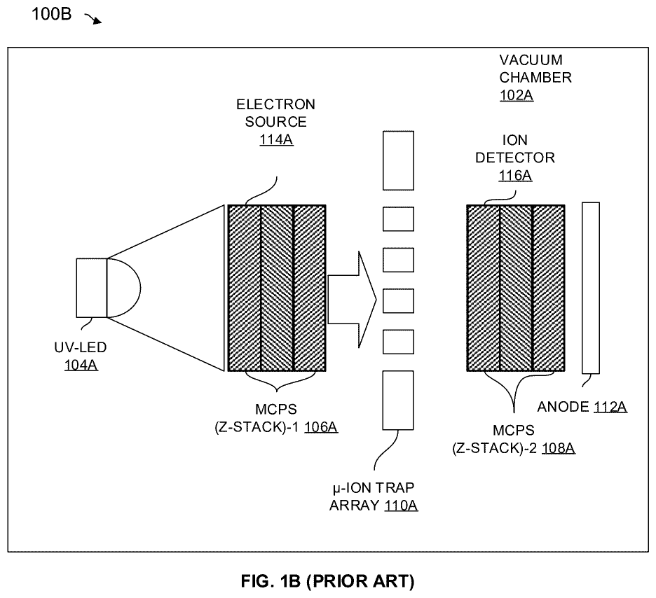

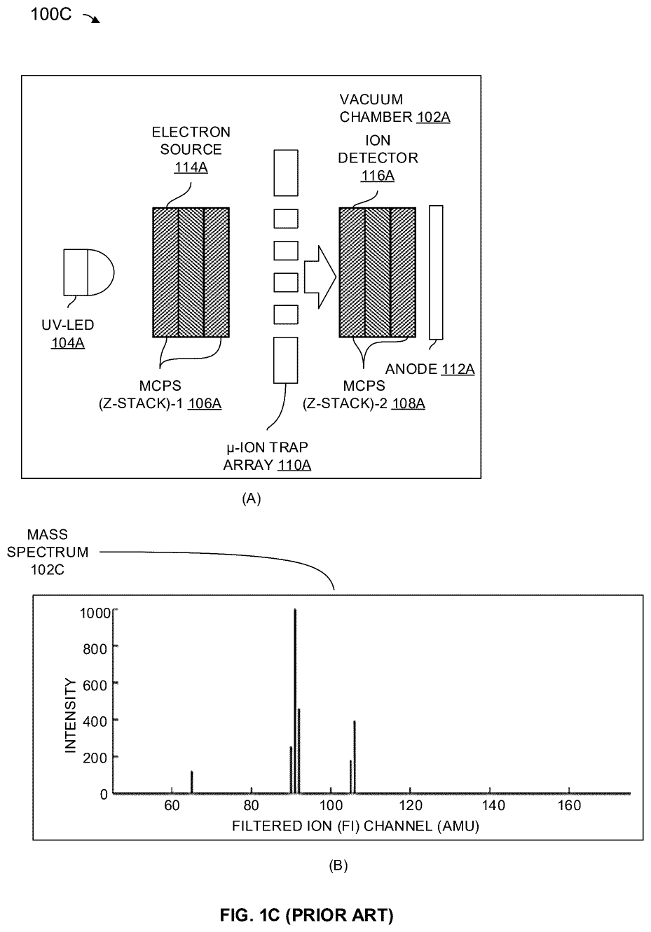

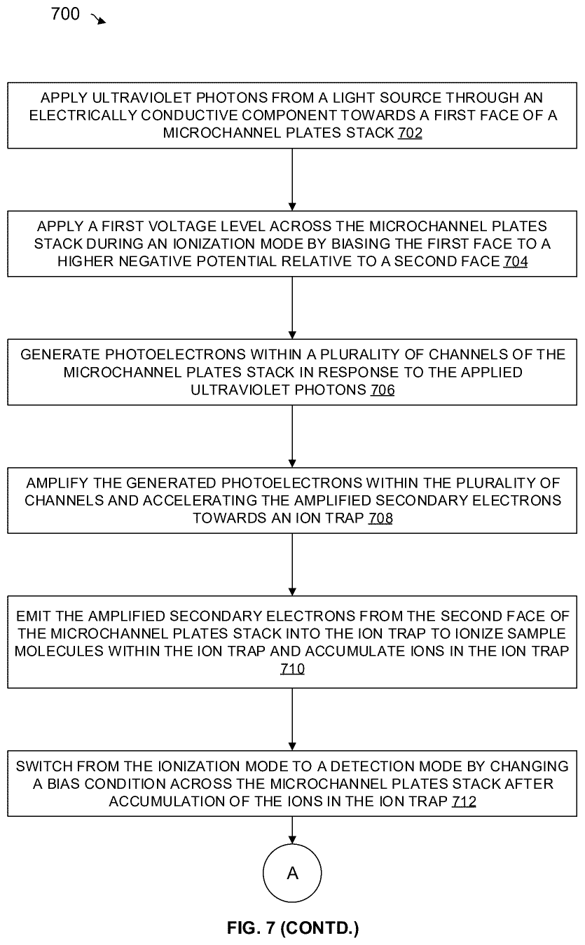

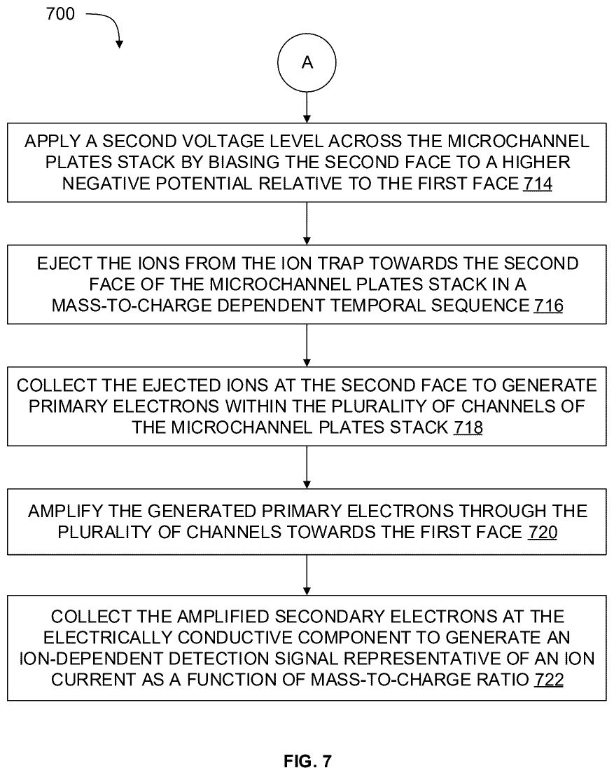

While the components, elements, circuits, and subsystems of the ion trap mass spectrometer assembly 200 described herein may be illustrated as single functional blocks and/or elements in the accompanying figures, it may be appreciated that each such block and/or element may represent a plurality of interconnected components and/or a plurality of circuits operating together to perform the described functions. Further, directional signal paths, control connections, and operational arrows depicted in FIGS. 1-7 may correspond to functional relationships and operational states of the mass spectrometer assembly, including ionization, ion trapping, ion ejection, and ion detection. Although the FIGS. 1-6 illustrate component relationships in a structural manner, a sequence and timing of a voltage application, a mode switching, and a signal propagation may follow an operational order defined by a plurality of control logic and timing schemes define in the method steps of FIG. 7.

The ion trap mass spectrometer assembly 200 may further include one or more auxiliary electronic circuits (not depicted in FIGS. 2-6) and/or one or more control elements (not depicted in FIGS. 2-6). The one or more auxiliary electronic circuits may provide support for at least one of a bias generation, a voltage regulation, a timing coordination, a signal conditioning, a synchronization between the ionization mode and the detection mode. Further, the one or more auxiliary electronic circuits may provide communication between the control circuit 210 and one or more detector circuits (not depicted in FIGS. 2-6). For example, the one or more auxiliary electronic circuits may be integrated within the control circuit 210, distributed across a plurality of electronic modules (not depicted in FIGS. 2-6), and/or omitted depending on at least one of a configuration, a form factor, and/or an operational requirement of the ion trap mass spectrometer assembly 200. Further, the ion trap mass spectrometer assembly 200 may include, such as, for example, but not limited to, one or more additional electronic components (not depicted in FIGS. 2-6) and/or one or more control components (not depicted in FIGS. 2-6). The one or more additional electronic components and/or the one or more control components may provide at least one of a monitoring, a diagnostics, a calibration, a data acquisition, and/or a supervisory control associated with an operation of the ion trap mass spectrometer assembly 200.

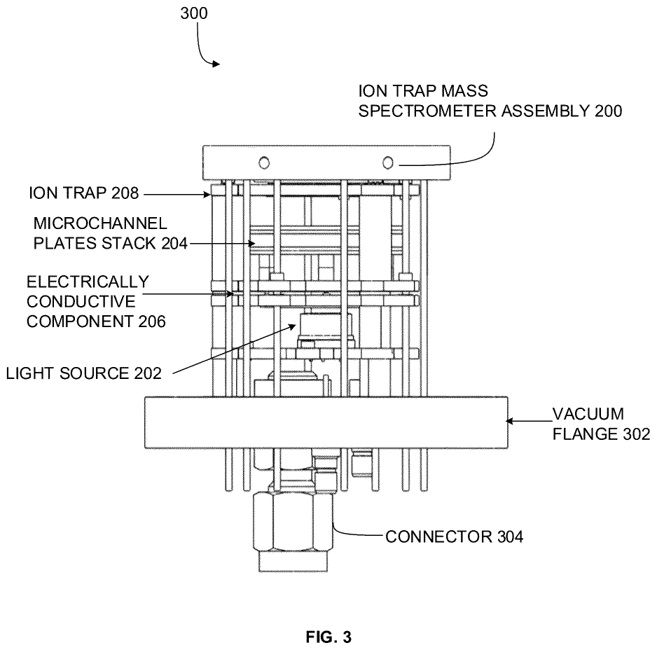

FIG. 3 illustrates an example structural representation depicting a physical configuration 300 of the ion trap mass spectrometer assembly 200 deploying the microchannel plates stack 204, according to an example. The ion trap mass spectrometer assembly 200 may represent a compact, and mechanically integrated mass spectrometer system. The ion trap mass spectrometer assembly 200 may be configured for at least one of an Electron Ionization Mass Spectrometry (EI-MS) operation. Further, the ion trap mass spectrometer assembly 200 may be suitable for use in at least one of a portable mass spectrometer platform and/or a handheld mass spectrometer platform. According to FIG. 3, the ion trap mass spectrometer assembly 200 may include, such as, for example, but not limited to, a stacked and coaxial arrangement of one or more internal components enclosed within a structural housing of the ion trap mass spectrometer assembly 200. The one or more internal components may include, such as, for example, but not limited to, the light source 202, the electrically conductive component 206, the microchannel plates stack 204, the ion trap 208, the control circuit 210, and the electronic pre-amplifier circuit 218 arranged along a common axis within the ion trap mass spectrometer assembly 200. The structural housing of the ion trap mass spectrometer assembly 200 may provide and align the light source 202, the electrically conductive component 206, the microchannel plates stack 204, and the ion trap 208 along a common longitudinal axis to form a linear ion optics stack. Further, an axial configuration of the ion trap mass spectrometer assembly 200 may provide an efficient electron transport during the ionization mode and an ion transport during the detection mode. Further, a vacuum flange 302 and a connector 304 may be provided. The vacuum flange 302 may include a mechanical interface, which may be configured to couple the ion trap mass spectrometer assembly 200 to the vacuum chamber (not depicted in FIG. 3) and/or an external vacuum system. Further, the vacuum flange 302 may be configured to maintain a sealed vacuum environment. Furthermore, the vacuum flange 302 may be configured to provide structural support for the ion trap mass spectrometer assembly 200. The connector 304 may include a fluidic coupling. Further, the connector 304 may be configured to introduce at least one of a gas and/or an analyte into the vacuum chamber, for example via at least one of a sealed tube and/or a fitting. Furthermore, the connector 304 may be configured to maintain a vacuum integrity during an operation of the ion trap mass spectrometer assembly 200. For example, the connector 304 may further provide a controlled sample delivery from an external source into the ion trap mass spectrometer assembly 200.

The ion trap mass spectrometer assembly 200 may further include, such as, for example, but not limited to, one or more mechanical support structures, one or more spacers, and one or more mounting features. Further, the ion trap mass spectrometer assembly 200 may be configured to maintain a fixed relative positioning of the microchannel plates stack 204 and the ion trap 208. Furthermore, the ion trap mass spectrometer assembly 200 may electrically isolate one or more selected components as required for at least one high-voltage operation. In addition, the one or more selected components, may include, such as, for example, but not limited to, the microchannel plates stack 204, the electrically conductive component 206, and a plurality of electrodes of the ion trap 208. Further, the one or more selected components may be electrically isolated from a structural housing of the ion trap mass spectrometer assembly 200 and from each of the one or more selected components. The one or more selected components may be electrically isolated to allow an application of a plurality of high voltage bias levels during the ionization mode and the detection mode without at least one of an electrical breakdown and/or one or more unintended current paths. Furthermore, one or more electrical feedthroughs and one or more interconnects within the ion trap mass spectrometer assembly 200 may extend through the structural housing to couple the one or more internal components to a plurality of external control electronics. The plurality of external control electronics may include, such as, for example, but not limited to, the control circuit 210 and the electronic pre-amplifier circuit 218. For example, the microchannel plates stack 204 within the ion trap mass spectrometer assembly 200 may be operable in at least one of the ionization mode and the detection mode under control of the control circuit 210. In the ionization mode, the microchannel plates stack 204 may act as an electron source. In the detection mode, the microchannel plates stack 204 acts as the ion detector. The physical configuration 300 of the ion trap mass spectrometer assembly 200 may depict a rapid switching between the ionization mode and the detection mode without a mechanical reconfiguration. The ion trap mass spectrometer assembly 200 may further be configured for an installation within the vacuum chamber coupled to a vacuum pump. Further, the ion trap mass spectrometer assembly 200 may provide at least one of a vacuum compatibility, an electrical isolation, and a thermal stability. Further, a compact and modular structure of the ion trap mass spectrometer assembly 200 may be shown in FIG. 3. The compact and modular structure of the ion trap mass spectrometer assembly 200 may reduce an alignment complexity and minimize an ion optical path length.

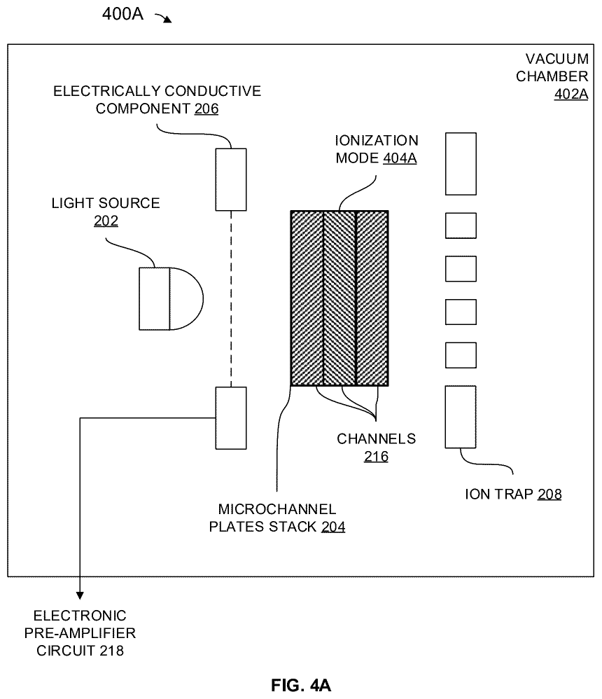

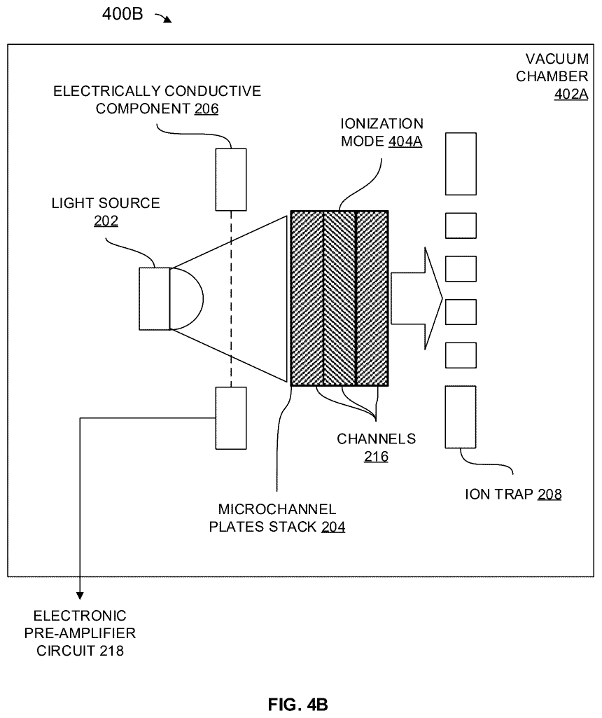

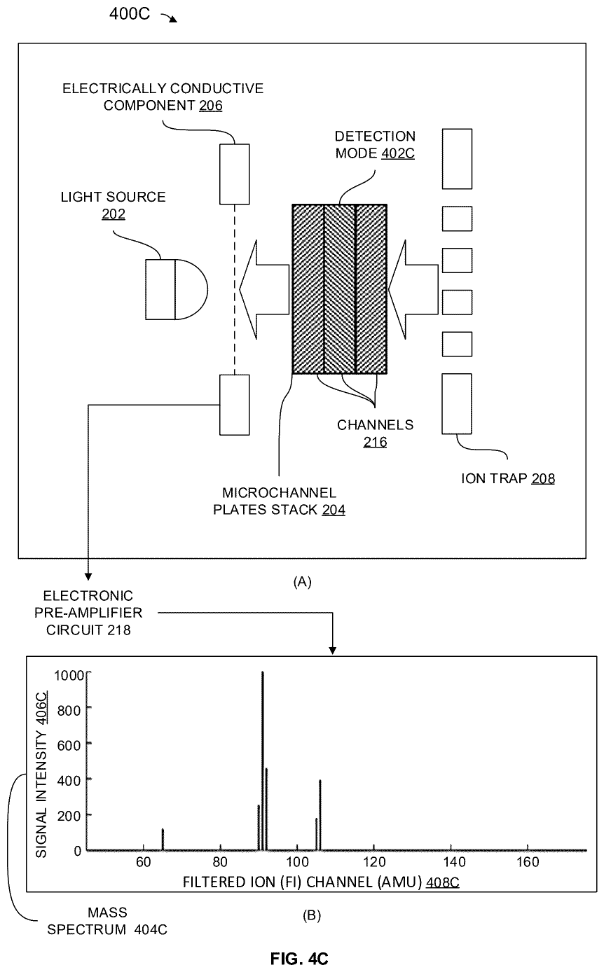

FIGS. 4A-4C illustrates example schematic representations depicting operational configurations of the ion trap mass spectrometer assembly 200 operating in the ionization mode 404A and the detection mode 402C, according to an example. According to FIG. 4A, a first operational configuration 400A of the ion trap mass spectrometer assembly 200 may be depicted. Further, in the first operational configuration 400A, the sample molecules may be introduced into the vacuum chamber 402A in proximity to the microchannel plates stack 204 and the ion trap 208. According to FIG. 4B, a second operational configuration 400B of the ion trap mass spectrometer assembly 200 may be depicted. The second operational configuration 400B may correspond to the ionization mode 404A, in which the light source 202 may emit the ultraviolet photons through the electrically conductive component 206 toward the first face 212 of the microchannel plates stack 204. In the second operational configuration 400B, the photoelectrons may be generated and amplified within the plurality of channels 216. Further, in the second operational configuration 400B, a broadened secondary electron beam may be emitted toward the ion trap 208 to ionize the sample molecules. In the ionization mode 404A, the microchannel plates stack 204 may amplify the generated photoelectrons within the plurality of channels 216 to an electron gain on an order of, for example, such as, but not limited to, 10⁶. The microchannel plates stack 204 may thereby generate the broadened secondary electron beam directed toward the ion trap 208 for ionization of the sample molecules. According to part (A) of FIG. 4C, a third operational configuration 400C of the ion trap mass spectrometer assembly 200 may be depicted. The third operational configuration 400C may correspond to the detection mode 402C. In the detection mode 402C, a bias polarity applied across the microchannel plates stack 204 may be reversed to collect the ions ejected from the ion trap 208. Further, in the detection mode 402C, the control circuit 210 may generate the secondary electrons within the plurality of channels 216. Furthermore, in the detection mode 402C, the control circuit 210 may amplify the secondary electrons. In addition, in the detection mode 402C, the control circuit 210 may provide the ion-dependent detection signal. The ion-dependent detection signal may be processed by the electronic pre-amplifier circuit 218 to generate a graphical representation of the mass spectrum 404C. In the detection mode 402C, the ions ejected from the ion trap 208 impinge on the microchannel plates stack 204 to generate the secondary electrons. The generated secondary electrons may be amplified within the plurality of channels 216 to a gain on an order of, such as, for example, but not limited to, 10⁶. Further, the ion-dependent detection signal may be generated within the ion trap mass spectrometer assembly 200. According to part (B) of FIG. 4C, the graphical representation of the mass spectrum 404C may be illustrated. The mass spectrum 404C may represent an example ion signal output generated by the ion trap mass spectrometer assembly 200 during the detection mode 402C. In the graphical representation of the mass spectrum 404C, a horizontal axis may correspond to a mass to charge related scan coordinate, represented as a Filtered Ion (FI) channel 408C. The FI channel 408C may represent a calibrated mass to charge value associated with a sequential ion ejection from the ion trap 208. The FI channel 408C may correspond to the calibrated mass to charge value expressed in Atomic Mass Units (AMUs). Further, in the graphical representation of the mass spectrum 404C, a vertical axis may correspond to a signal intensity 406C. The signal intensity 406C may represent a magnitude of the ion-dependent detection signal. The ion-dependent detection signal may be generated by the secondary electrons. The secondary electrons may be amplified by the microchannel plates stack 204. Further, the secondary electrons may be processed by the electronic pre-amplifier circuit 218. Furthermore, a plurality of peaks appearing at a plurality of distinct positions along the FI channel 408C may indicate detection of the ions. The ions may have a plurality of different mass to charge ratios. Further, a plurality of relative peak heights along an axis of the signal intensity 406C may correspond to a relative ion abundance within an analyzed sample present in the ion trap 208.

In a simulated example, the mass spectrum 404C may be generated for an air sample at a pressure on the order of approximately 10⁻³ Torr using an ion accumulation interval followed by a mass to charge scan interval. The ion accumulation interval may be of approximately 12 milliseconds. Further, the mass to charge scan interval may be of approximately 10 milliseconds.

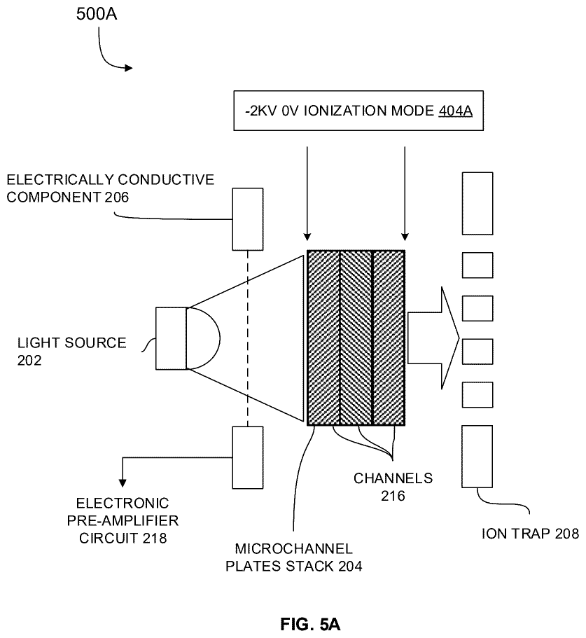

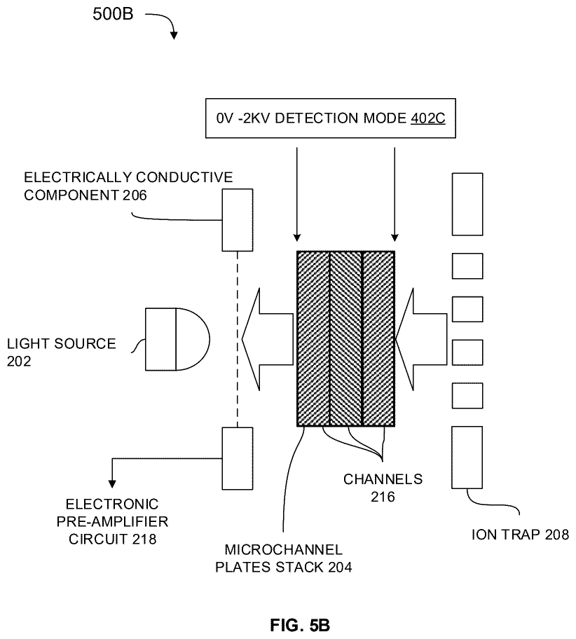

FIG. 5A illustrates an example schematic representation of an operational configuration 500A of the ion trap mass spectrometer assembly 200 depicting a generalized architecture in which the microchannel plates stack 204 operates in the ionization mode 404A, according to an example. According to FIG. 5A, the microchannel plates stack 204, including the plurality of channels 216, may be selectively operated under a control of the control circuit 210. The microchannel plates stack 204 may be configured to operate alternately in the ionization mode 404A and the detection mode 402C. Further, in the ionization mode 404A, the ultraviolet photons emitted from the light source 202 may pass through the electrically conductive component 206. The ultraviolet photons may be passed through the electrically conductive component 206 to generate and amplify the secondary electrons within the plurality of channels 216. The amplified secondary electrons may be emitted toward the ion trap 208 to ionize the sample molecules. In the detection mode 402C, the ions ejected from the ion trap 208 may impinge on the microchannel plates stack 204 to generate the secondary electrons. The secondary electrons may be collected at the electrically conductive component 206. Further, the secondary electrons may be conveyed to the electronic pre-amplifier circuit 218 to generate the ion-dependent detection signal.

FIG. 5B illustrates an example schematic representation of an operational configuration 500B of the ion trap mass spectrometer assembly 200 depicting an operational directionality and a mode dependent behavior of the microchannel plates stack 204, according to an example. According to FIG. 5B, the microchannel plates stack 204 operating during the detection mode 402C may be depicted. During the detection mode 402C, a polarity across the microchannel plates stack 204 may be reversed such that the ions ejected from the ion trap 208 may be directed toward the second face 214 of the microchannel plates stack 204. Further, the second face 214 of the microchannel plates stack 204 generating the secondary electrons within the plurality of channels 216 may be amplified and collected at the electrically conductive component 206. Further, the amplified secondary electrons may be conveyed to the electronic pre-amplifier circuit 218.

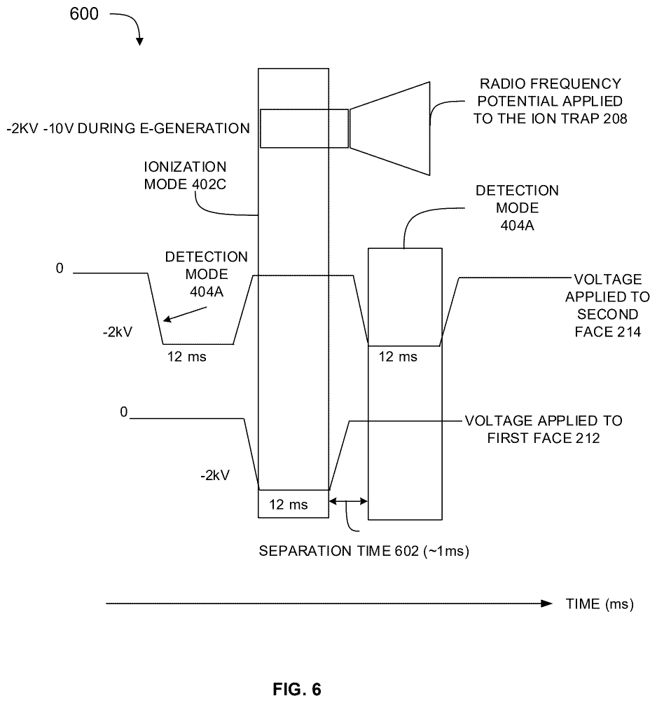

FIG. 6 illustrates an example schematic representation of a timing and biasing configuration 600 associated with the ion trap mass spectrometer assembly 200, such as shown in FIGS. 5A-5B, according to an example. According to FIG. 6, a plurality of waveforms generating a plurality of alternating bias conditions applied across the microchannel plates stack 204 may be depicted. The plurality of alternating bias conditions applied across the microchannel plates stack 204 may temporally separate the ionization mode 404A and the detection mode 402C. During a first-time interval, a first voltage polarity may be applied to accelerate secondary electrons toward the ion trap 208 for ion generation and accumulation. During a subsequent time interval, the first voltage polarity across the microchannel plates stack 204 may be reversed to provide the ion detection. The ions ejected from the ion trap 208 may traverse a separation time 502B. Further, the ion trap 208 may generate the secondary electrons within the plurality of channels 216. Furthermore, timing intervals and voltage levels depicted in FIG. 6 may be illustrative and adjusted to optimize at least one of an ion accumulation, an ion ejection, and a detection performance of the ion trap mass spectrometer assembly 200. According to FIG. 6, the timing and biasing configuration 600 may be depicted. In FIG. 6, the separation time 602 between the ionization mode 404A and the detection mode 402C may be typically about 1 milli second (ms). Further, the separation time 602 may be empirically optimized. Furthermore, a bias level of approximately −2 kV may be applied across the microchannel plates stack 204 during the ionization mode 404A and the detection mode 402C for at least one of an electron acceleration and/or an ion collection. In addition, a duration of approximately 12 ms may define a respective ionization and detection time window. Further, a voltage applied to the first face 212 and a voltage may be applied to the second face 214 of the microchannel plates stack 204 in a time multiplexed manner to alternate between the ionization mode 402C and the detection mode 404A may be depicted. Further, a Radio Frequency (RF) potential applied to the ion trap 208 to confine the ions during accumulation. Further, the separation time may be depicted as time intervals (in milliseconds) to represent an example duration for at least one of a bias application, a mode switching, and an ion separation within the ion trap mass spectrometer assembly 200.

According to in FIGS. 5A-5B and FIG. 6, the microchannel plates stack 204 may be configured to perform the electron generation during the ionization mode 404A and the ion detection during the detection mode 402C. The microchannel plates stack 204 may be, such as, for example, but not limited to, a single microchannel plate and/or a stack of the one or more microchannel plates. Further, one or more ultraviolet light sources may be positioned at a first end of an ion optics stack, with the ultraviolet photons transmitted through the electrically conductive component 206 toward the first face 212 of the microchannel plates stack 204. Further, the ion trap 208 may be disposed adjacent to the second face 214 of the microchannel plates stack 204. During the ionization mode 404A, the first face 212 of the microchannel plates stack 204 may be biased to a high negative potential relative to the second face 214. The second face 214 may be, for example, such as, but not limited to, at and/or a near ground potential, such that the ultraviolet photons incident within the plurality of channels 216 of the microchannel plates stack 204 may generate and amplify the secondary electrons. The amplified secondary electrons may be emitted from the second face 214 and directed into the ion trap 208 through an annular electrode to ionize the sample molecules. After an ion accumulation within the ion trap 208, the control circuit 210 may reverse the bias polarity across the microchannel plates stack 204 to transition to the detection mode 402C. In the detection mode 402C, the second face 214 may be biased to a high negative potential relative to the first face 212. Further, positive ions ejected from the ion trap 208 may then be accelerated toward the second face 214 of the microchannel plates stack 204. Further, the second face 214 of the microchannel plates stack 204 may generate the secondary electrons within the plurality of channels 216. Furthermore, the generated secondary electrons may be amplified toward the first face 212. In addition, the amplified secondary electrons may be collected at the electrically conductive component 206. The electrically conductive component 206 may function as a detection anode to provide the ion-dependent detection signal.

In an example, a full measurement cycle of the ion trap mass spectrometer assembly 200 may include a sequence of one or more operating intervals. The one or more operating intervals may include, such as, for example, but not limited to, an ultraviolet illumination interval, an ion accumulation interval, a polarity switching interval an ion ejection interval. During the ultraviolet illumination interval, the photoelectrons may be injected from the microchannel plates stack 204. During the ion accumulation interval, the ions may be stored within the ion trap 208. During, the polarity switching interval, the bias condition applied across the microchannel plates stack 204 may be reversed. During, the detection interval, the ions may be detected by the microchannel plates stack 204. For example, one or more timing relationships for the one or more operating intervals may be illustrated in FIGS. 5A-5B and FIG. 6. The ion trap mass spectrometer assembly 200 may be operated with an overall measurement cycle repetition rate on an order of, such as, for example, but not limited to, approximately 10 hertz to approximately 20 hertz. Further, a desired mass to charge range may be covered by performing a mass analysis. The mass analysis may be performed using a plurality of mass segments. The plurality of mass segments may include, such as, for example, but not limited to, at least two mass segments. The at least two mass segments may be configured to collectively span a range from, such as, for example, but not limited to, 28 amu to about 210 amu. Further, a greater number of mass segments may be applied as needed to achieve a selected mass range and/or resolution within the ion trap mass spectrometer assembly 200.

FIG. 7 illustrates an example flow diagram representation of a method 700 of operating the ion trap mass spectrometer assembly 200, according to an example.

At block 702, the method 700 may include applying ultraviolet photons from the light source 202. The ultraviolet photons may be applied through the electrically conductive component 206 towards the first face 212 of the microchannel plates stack 204.

At block 704, the method 700 may include applying a first voltage level across the microchannel plates stack 204 during the ionization mode 404A by biasing the first face 212 to a higher negative potential relative to the second face 214.

At block 706, the method 700 may include generating the photoelectrons within the plurality of channels 216 of the microchannel plates stack 204 in response to the applied ultraviolet photons.

At block 708, the method 700 may include amplifying the generated photoelectrons within the plurality of channels 216 and accelerating the amplified secondary electrons towards the ion trap 208.

At block 710, the method 700 may include emitting the amplified secondary electrons from the second face 214 of the microchannel plates stack 204 into the ion trap 208 to ionize sample molecules within the ion trap 208. The ion trap 208 may accumulate the ions in the ion trap 208.

At block 712, the method 700 may include switching from the ionization mode 404A to the detection mode 402C by changing a bias condition across the microchannel plates stack 204 after accumulation of the ions in the ion trap 208.

At block 714, the method 700 may include applying a second voltage level across the microchannel plates stack 204 by biasing the second face 214 to a higher negative potential relative to the first face 212. The second voltage level may include a polarity opposite to a polarity of the first voltage level.

At block 716, the method 700 may include ejecting the ions from the ion trap 208 towards the second face 214 of the microchannel plates stack 204 in a mass-to-charge dependent temporal sequence.

At block 718, the method 700 may include collecting the ejected ions at the second face 214 to generate primary electrons within the plurality of channels 216 of the microchannel plates stack 204.

At block 720, the method 700 may include amplifying the generated primary electrons through the plurality of channels 216 towards the first face 212.

At block 722, the method 700 may include collecting the amplified secondary electrons at the electrically conductive component 206 to generate the ion-dependent detection signal representative of an ion current as a function of mass-to-charge ratio.

In an example, the method 700 may include operating a dual function microchannel plate in the ion trap mass spectrometer assembly 200 may be provided. The method 700 may include illuminating the microchannel plates stack 204 with the ultraviolet photons to generate the photoelectrons within microchannels. Further, the method 700 may include applying a first voltage polarity to accelerate the secondary electrons toward the ion trap 208 to ionize the sample molecules. Furthermore, the method 700 may include trapping the ions within the ion trap 208. In addition, the method 700 may include reversing the voltage polarity applied to the microchannel plates stack 204. Further, the method 700 may include detecting the ions by secondary electron emission generated by ion impact on the microchannel plates stack 204.

The method 700 may further include temporally separating a plurality of operations to prevent overlap between electron emission and ion detection. The plurality of operations may include applying a first voltage polarity to accelerate the secondary electrons toward the ion trap 208 to ionize sample molecules. Furthermore, the plurality of operations may include trapping the ions within the ion trap 208. In addition, plurality of operations may include reversing the voltage polarity applied to the microchannel plates stack 204. Further, the plurality of operations may include detecting ions by primary electrons generated by ion impact on the microchannel plates stack 204.

In an example, the method 700 may include applying ultraviolet light through the electrically conductive component 206 toward the microchannel plates stack 204 to generate the photoelectrons within the plurality of channels 216 of the microchannel plates stack 204. The method 700 may further include applying the first voltage level across the microchannel plates stack 204 to amplify the generated photoelectrons generating secondary electrons. Further, the method 700 may include accelerating the amplified secondary electrons toward the ion trap 208. Furthermore, the method 700 may include receiving the amplified secondary electrons at the ion trap 208 to ionize the sample molecules. Further, after an ion accumulation within the ion trap 208, the method 700 may further include ejecting the ions from the ion trap 208 toward the microchannel plates stack 204. Furthermore, the method 700 may include applying the second voltage level across the microchannel plates stack 204. The second voltage level may include a polarity opposite to the first voltage level, to amplify the primary electrons. The primary electrons may be generated by at least one of an ion impact. Further, the method 700 may include accelerating the amplified secondary electrons toward the electrically conductive component 206. The method 700 may further include collecting the amplified secondary electrons at the electrically conductive component 206 to generate the ion-dependent detection signal. The ion-dependent detection signal may be representative of the detected ions.

The order in which the method 700 may be described may not be intended to be construed as a limitation, and any number of the described method blocks may be combined or otherwise performed in any order to implement the method 700 or an alternate method. Additionally, individual blocks may be deleted from the method 700 without departing from the spirit and scope of the ongoing description. Furthermore, the method 700 may be implemented using any suitable combination of a hardware circuitry, a control logic, a firmware, and/or a software, whether currently available and/or later developed, to control operation of the ion trap mass spectrometer assembly 200 as described herein. The method 700 describes, without limitation, the implementation of the ion trap mass spectrometer assembly 200. A person of skill in the art will understand that method 700 may be modified appropriately for implementation in various manners without departing from the scope and spirit of the ongoing description.

Various examples herein provide the dual-function ion trap mass spectrometer assembly 200 with integrated ionization and detection, and the method 700 thereof. The present disclosure may provide the ion trap mass spectrometer assembly 200. Further, the present disclosure may provide a simplified mass spectrometry architecture in which the microchannel plates stack 204 may be selectively operable as at least one of the electron source during the ionization mode 404A and the ion detector during the detection mode 402C. Further, a functionality of the ionization mode 404A and the detection mode 402C may be combined within a shared component, such as, for the microchannel plates stack 204. Therefore, the ion trap mass spectrometer assembly 200 may reduce a number of one or more discrete ion optical elements, which may conventionally be required in a mass spectrometer system. The one or more discrete ion optical elements, may include, such as, for example, but not limited to, a plurality of separate electron sources, a plurality of standalone ionization stages, a plurality of independent ion detection stages, a plurality of electron multipliers, and/or a plurality of dedicated ion-optical focusing components. Further, the one or more discrete ion optical elements may be conventionally required in a mass spectrometer architecture. Therefore, the ion trap mass spectrometer assembly 200 may provide a simplified architecture and a control mechanism.

Further, the present disclosure may provide substantial technical advantages over conventional ion trap mass spectrometers by integrating an ion source function and an ion detection function into a single dual function microchannel plate module. Further, an integration of the ion source function and the ion detection function may eliminate a dedicated detector assembly. The present disclosure may provide a reduction in a volume of the vacuum chamber 402A on the order of up to approximately two times, for example from approximately, such as, for example, but not limited to, 50 cubic centimeters to approximately 25 cubic centimeters. Further, a reduction in the volume of the vacuum chamber 402A may accelerate an initial evacuation time from on the order of approximately 30 minutes to less than approximately 5 minutes. The present disclosure may thereby provide using one or more smaller turbomolecular pumps for the vacuum chamber 402A. The one or more smaller turbomolecular pumps may include, such as, for example, but not limited to, a lower pumping speed. The lower pumping speed may be for example on the order of approximately 10 liters per second as opposed to approximately 25 liters per second used in the conventional ion trap mass spectrometers.

Further, the present disclosure may provide a compact linear ion optics stack. The compact linear ion optics stack may include the light source 202, the microchannel plates stack 204, the electrically conductive component 206, and the ion trap 208. The compact linear ion optics stack may simplify the ion trap mass spectrometer assembly 200 by reducing a component count and a number of a plurality of electrical feedthroughs and a plurality of vacuum feedthroughs by on the order of at least approximately 30 percent. Further, the ion trap mass spectrometer assembly 200 may provide mechanical ruggedness and stacking tolerances, which may be advantageous for at least one of a handheld implementation and/or a portable implementation.

The present disclosure may provide a reduction in the one or more discrete ion optical elements. Further, the reduction in the one or more discrete ion optical elements may provide a compact ion optics stack, which in turn may allow a reduction in a volume of the vacuum chamber 402A. The vacuum chamber 402A may enclose the light source 202, the microchannel plates stack 204, and the ion trap 208. The present disclosure may provide the vacuum chamber 402A, which may be smaller as compared to a conventional vacuum chamber. Therefore, the vacuum chamber 402A of the present disclosure may provide a faster evacuation during at least one of a startup vacuum requirement and a relaxed vacuum requirement during an operation of the ion trap mass spectrometer assembly 200. Therefore, the vacuum chamber 402A of the present disclosure may improve responsiveness of the ion trap mass spectrometer assembly 200. Further, the present disclosure may provide an integration of the ion trap mass spectrometer assembly 200 into at least one of a portable spectrometer platform and/or a compact mass spectrometer platform.

The present disclosure may provide a compact and coaxial arrangement of the one or more internal components of the ion trap mass spectrometer assembly 200. The one or more internal components may include, such as, for example, but not limited to, the light source 202, the electrically conductive component 206, the microchannel plates stack 204, the ion trap 208, the control circuit 210, and the electronic pre-amplifier circuit 218. Further, the compact and coaxial arrangement of the one or more internal components may improve at least one of a stacking tolerance and a mechanical reliability of the ion trap mass spectrometer assembly 200. The present disclosure may provide shortening a plurality of ion optical path lengths. Further, the present disclosure may provide reducing an alignment sensitivity between the ionization mode 404A and the detection mode 402C. Therefore, the ion trap mass spectrometer assembly 200 may enhance at least one of reproducibility, manufacturability, and resistance to a mechanical disturbance during at least one of a fabrication, an integration, and an operation of the ion trap mass spectrometer assembly 200.

Additionally, an elimination of a separate ion detection mode and/or a separate electron source mode may reduce a complexity and a plurality of servicing requirements of the ion trap mass spectrometer assembly 200. Further, the complexity and the plurality of servicing requirements may be reduced by decreasing a number of at least one of a plurality of high voltage components, a plurality of interfaces, and a plurality of replacement parts. Collectively, at least one of one or more architectural and one or more operational advantages result in the ion trap mass spectrometer assembly 200, which may be simpler to assemble, more reliable in operation, and better suited for a scalable manufacturing and deployment.

The present disclosure may be directed toward a further miniaturization of an electron impact mass spectrometer architecture by employing the microchannel plates stack 204. The microchannel plates stack 204 may be configured to operate as an electron source in the ionization mode 404A and as the ion detector in the detection mode 402C. Further, the present disclosure may provide a simplified assembly of the ion trap mass spectrometer assembly 200. Furthermore, the present disclosure may provide a reduction in an overall component count of the one or more components of the ion trap mass spectrometer assembly 200. In addition, the present disclosure may provide a decrease in a volume of the ion trap mass spectrometer assembly 200. The electrically conductive component 206 may include, such as, for example, but not limited to, a metallized silicon nitride mesh. The electrically conductive component 206 may provide an improved mechanical,

The present disclosure may provide a validation of high voltage polarity switching, an attenuation of the ultraviolet photons at the electrically conductive component 206, and a collection efficiency of the secondary electrons during the detection mode 402C. Further, an application of a positive bias voltage to the electrically conductive component 206 may be used to improve the collection efficiency of the photoelectrons. Additionally, the electronic pre-amplifier circuit 218 may be configured and/or optimized to accommodate signal characteristics associated with a combined generation of the photoelectrons and an ion detection operation.

One of ordinary skill in the art will appreciate that techniques consistent with the ongoing description are applicable in other contexts as well without departing from the scope of the ongoing description.

As mentioned above, what is shown and described with respect to the ion trap mass spectrometer assemblies and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing handoff.

It should also be appreciated that the ion trap mass spectrometer assemblies and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, ion trap mass spectrometer assemblies, and methods described herein, and may include volatile and/or non-volatile data storage that may store data and software or firmware including machine-readable instructions. The software or firmware may include subroutines or applications that perform the functions of the measurement system and/or run one or more applications that utilize data from the measurement or other communicatively coupled system.

The various components, circuits, elements, components, and interfaces may be any number of mechanical, electrical, hardware, network, and/or software components, circuits, elements, and interfaces that serve to facilitate communication, exchange, and analysis data between any number of or combination of equipment, protocol layers, or applications. For example, the components described herein may each include a network and/or communication interface to communicate with other servers, devices, components, and/or network elements via a network or other communication protocol.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims and their equivalents in which all terms are meant in their broadest reasonable sense unless otherwise indicated.

1. An ion trap mass spectrometer assembly comprising:
a light source configured to emit ultraviolet photons;
a microchannel plates stack comprising: a first face opposite to a second face and a plurality of channels extending between the first face and the second face;
an electrically conductive component disposed between the light source and the first face of the microchannel plates stack, wherein the electrically conductive component being configured to transmit at least a portion of the ultraviolet photons toward the microchannel plates stack and to collect electrons exiting the microchannel plates stack;
an ion trap disposed adjacent to the second face of the microchannel plates stack a control circuit; and
a control circuit configured to operate the microchannel plates stack in at least one of an ionization mode and a detection mode, and wherein the microchannel plates stack acts as an electron source during the ionization mode and the microchannel plates stack acts as an ion detector during the detection mode.

2. The ion trap mass spectrometer assembly of claim 1, wherein in the ionization mode, the control circuit is configured to:
generate photoelectrons within the plurality of channels of the microchannel plates stack using the ultraviolet photons by applying a first voltage level across the first face of the microchannel plates stack relative to the second face;
amplify the generated photoelectrons and accelerate the amplified secondary electrons towards the ion trap; and
emit the amplified secondary electrons from the second face of the microchannel plates stack towards the ion trap to ionize sample molecules within the ion trap.

3. The ion trap mass spectrometer assembly of claim 1, wherein in the detection mode, the control circuit is configured to:
apply a second voltage level across the second face of the microchannel plates stack, wherein the second voltage level comprises a polarity opposite to a polarity of the first voltage level;
collect ions ejected from the ion trap towards the second face to generate primary electrons within the plurality of channels of the microchannel plates stack upon applying the second voltage level;
amplify the generated primary electrons through the plurality of channels toward the first face; and
collect the amplified secondary electrons at the electrically conductive component to generate an ion-dependent detection signal.

4. The ion trap mass spectrometer assembly of claim 1, further comprising an electronic pre-amplifier circuit connected to the electrically conductive component, and wherein the electronic pre-amplifier circuit is configured to amplify the ion-dependent detection signal collected at the electrically conductive component.

5. The ion trap mass spectrometer assembly of claim 1, wherein the light source comprises at least one ultraviolet light emitting diode arranged to illuminate a surface area of the microchannel plates stack corresponding to the plurality of channels.

6. The ion trap mass spectrometer assembly of claim 1, wherein the microchannel plates stack comprises at least one of a single plate and two or more plates arranged in a stacked configuration, and wherein each of the plurality of channels of the microchannel plates stack comprises a diameter in a range from 0.1 μm to 100 μm.

7. The ion trap mass spectrometer assembly of claim 1, wherein the electrically conductive component comprises at least one of a membrane coated with a conductive metal layer and a conductive mesh comprising a plurality of pores of diameters in a range from 0.01 μm to 1000 μm.

8. The ion trap mass spectrometer assembly of claim 1, wherein the ion trap comprises a quadrupole ion trap comprising an annular plate electrode configured to admit electrons emitted from the second face of the microchannel plates stack into a central trapping region of the ion trap.

9. The ion trap mass spectrometer assembly of claim 2, wherein the first voltage level biases the first face of the microchannel plates stack to a higher negative potential relative to the second face, wherein the second face is configured with at least one of a ground potential and a low negative voltage level to accelerate the amplified secondary electrons towards the ion trap.

10. The ion trap mass spectrometer assembly of claim 3, wherein the second voltage level biases the second face of the microchannel plates stack to a higher negative potential relative to the first face, wherein the first face is configured with at least one of a ground potential and a low negative potential, wherein the ions impinging on the second face of the microchannel plates stack generate primary electrons, and wherein the primary electrons are then accelerated and amplified toward the electrically conductive component.

11. The ion trap mass spectrometer assembly of claim 2, wherein the first voltage level comprises a potential difference across the microchannel plates stack, wherein the potential difference lies within a range of about 500 V to about 1 kV per microchannel plate, and/or a range of about 1 kV to about 3 kV across the microchannel plates stack comprising at least two microchannel plates.

12. The ion trap mass spectrometer assembly of claim 3, wherein the second voltage level comprises a potential difference across the microchannel plates stack, wherein the potential difference lies within a range of about 500 V to about 1 kV per microchannel plate, and/or a range of about 1 kV to about 3 kV across the microchannel plates stack comprising at least two microchannel plates.

13. The ion trap mass spectrometer assembly of claim 1, further comprising a vacuum chamber enclosing the light source, the electrically conductive component, the microchannel plates stack, and the ion trap, wherein the vacuum chamber being coupled to a vacuum pump.

14. The ion trap mass spectrometer assembly of claim 1, wherein the light source, the electrically conductive component, the microchannel plates stack, and the ion trap are configured as a compact mass spectrometer engine.

15. The ion trap mass spectrometer assembly of claim 1,
wherein the control circuit is further configured to operate the microchannel plates stack as an electron source and an ion detector.

16. The ion trap mass spectrometer assembly of claim 1, wherein the ion trap is configured to eject ions selectively and symmetrically towards one microchannel plate of the microchannel plates stack.

17. The ion trap mass spectrometer assembly of claim 1, wherein:
the microchannel plates stack acts as the electron source during the ionization mode for a first-time interval, wherein the ion trap is configured to accumulate ions generated by electrons emitted from the second face;
the microchannel plates stack acts as the ion detector during the detection mode for a second time interval subsequent to the first-time interval, wherein the ion trap is configured to eject the ions towards the second face; and
the control circuit is configured to switch the microchannel plates stack between the ionization mode and the detection mode based on at least one parameter, wherein the at least one parameter comprises an elapsed ionization time corresponding to a target ion accumulation period, a measured ion population level within the ion trap, a mass-analysis scan trigger from an external controller, and a monitored pressure and an operating condition within the vacuum chamber.

18. The ion trap mass spectrometer assembly of claim 17, wherein the control circuit is configured to:
terminate the first voltage level and apply the second voltage level in response to a control signal indicating completion of ion accumulation; and
terminate the second voltage level and re-apply the first voltage level after completion of a mass-to-charge scan of the ion trap.

19. A method of operating an ion trap mass spectrometer assembly comprising:
applying, by a control circuit, ultraviolet photons from a light source through an electrically conductive component towards a first face of a microchannel plates stack;
applying, by the control circuit, a first voltage level across the microchannel plates stack during an ionization mode by biasing the first face to a higher negative potential relative to a second face;
generating, by the control circuit, photoelectrons within a plurality of channels of the microchannel plates stack in response to the applied ultraviolet photons;
amplifying, by the control circuit, the generated photoelectrons within the plurality of channels and accelerating the amplified secondary electrons towards an ion trap;
emitting, by the microchannel plates stack, the amplified secondary electrons from the second face of the microchannel plates stack into the ion trap to ionize sample molecules within the ion trap and accumulate ions in the ion trap;
switching, by the control circuit, from the ionization mode to a detection mode by changing a bias condition across the microchannel plates stack after accumulation of the ions in the ion trap;
applying, by the control circuit, a second voltage level across the microchannel plates stack by biasing the second face to a higher negative potential relative to the first face, wherein the second voltage level comprises a polarity opposite to a polarity of the first voltage level;
ejecting, by the ion trap, the ions from the ion trap towards the second face of the microchannel plates stack in a mass-to-charge dependent temporal sequence;
collecting, by the microchannel plates stack, the ejected ions at the second face to generate primary electrons within the plurality of channels of the microchannel plates stack;
amplifying, by the control circuit, the generated primary electrons through the plurality of channels towards the first face; and
collecting, by the electrically conductive component, the amplified secondary electrons at the electrically conductive component to generate an ion-dependent detection signal representative of an ion current as a function of mass-to-charge ratio.
